(19) United States
(12) Patent Application Publication
(10) Pub. No.: US 2026/0201497 A1
(43) Pub. Date: Jul. 16, 2026

(54) METHOD OF EXTRACTING METAL IONS

(71) Applicant: FUJIFILM Corporation, Tokyo (JP)

(72) Inventors: Yo KUSHIDA, Kanagawa (JP); Hiroaki MOCHIZUKI, Kanagawa (JP); Toshihiro KAMADA, Kanagawa (JP)

(73) Assignee: FUJIFILM Corporation, Tokyo (JP)

(21) Appl. No.: 19/557,076

(22) Filed: Mar. 4, 2026

Related U.S. Application Data
(63) Continuation of application No. PCT/JP2024/033917, filed on Sep. 24, 2024.

(30) Foreign Application Priority Data
Sep. 27, 2023 (JP) 2023-165476
Mar. 29, 2024 (JP) 2024-055406

(51) Int. Cl. C22B 3/38; C22B 3/00

(52) U.S. Cl. CPC C22B 3/3846; C22B 23/0461

(57) ABSTRACT

Provided is a method of extracting metal ions in which a water phase including metal ions and an oil phase including an acidic extractant are combined to be mixed while flowing, subsequently the mixture is phase-separated into a water phase and an oil phase to extract the metal ions to the oil phase, and a content of the acidic extractant in the oil phase that is caused to flow is 35% to 100% by volume, the method including: a step of reducing a flow diameter of each of the water phase and the oil phase that are flowing, combining the water phase and the oil phase, and continuously causing a two-liquid combined solution to flow; a step of combining the water phase, the oil phase, and a pH adjusting agent aqueous solution and additionally causing a three-liquid combined solution to flow; and a step of phase-separating the three-liquid combined solution after extraction of metal ions to be extracted reaches an extraction equilibrium.

### CROSS-REFERENCE TO RELATED APPLICATIONS

This application is a Continuation of PCT International Application No. PCT/JP2024/033917 filed on Sep. 24, 2024, which claims priority under 35 U.S.C. § 119(a) to Japanese Patent Application No. 2023-165476 filed in Japan on Sep. 27, 2023 and JP2024-055406 filed on Mar. 29, 2024. Each of the above applications is hereby expressly incorporated by reference, in its entirety, into the present application.

### BACKGROUND OF THE INVENTION

### 1. Field of the Invention

The present invention relates to a method of extracting metal ions.

### 2. Description of the Related Art

Valuable metals such as noble metals or rare earth metals are essential elements for precision equipment, and stable supply and acquisition of the valuable metals with high purity are a big challenge. The valuable metals are typically mined as a mixture of plural kinds of metals. Therefore, the desired valuable metals need to be isolated and purified (high purity) from the mined mixture. Valuable metals that can be mined from mines are limited, and stable supply of noble metals required for precision equipment is a big challenge. Accordingly, a technique of recovering valuable metals from industrial waste irrespective of mining has been considered as important. In particular, along with the spread of electric vehicles, the amount of lithium ion batteries (LiB) wasted has been increasing every year. In LiB, a positive electrode active material including a metal element such as cobalt or nickel is used, and a significant increase in the demand for cobalt or nickel is also expected. In order to deal with the increase in the demand for valuable metals along with the trend, not only an increase in the amount of mining but also establishment of a technique of recycling waste LiB into a metal are desired.

As the isolated purification method of a desired valuable metal from the mined mixture and the method of recycling waste into a metal, a wet extraction method (solvent extraction method) is widely used. In the wet extraction method, in a case where an aqueous solution (water phase) including ions of a metal element (simply referred to as metal ions) and an organic phase including a metal extractant are brought into contact with each other, mixed, and left to stand to separate the two phases, the metal ions to which the metal extractant is coordinated are moved (extracted) to the organic phase. By extracting the organic phase, stripping the metal ions, and optionally purifying the metal ions, a desired metal can be isolated and purified, and the waste can be recycled as a (high-purity) metal.

As the wet extraction method, recently, for example, in order to improve extraction workability, there has been investigated a flow type extraction method of extracting metal ions in an oil phase to a water phase by combining the water phase and the oil phase while causing the water phase and the oil phase to flow.

For example, JP2016-019939A describes
“an extraction method of extracting a specific component from a material fluid to an extractant by using an extraction device which includes plural stages of extraction units, the extraction units each having a flow path adapted for extraction and being connected to one another such that at least a part of the fluid discharged from the flow path of the extraction unit for each of the stages is supplied to the flow path of the extraction unit for the next stage, the extraction method including:
an extraction step of extracting the specific component from the material fluid to the extractant while allowing the material fluid and the extractant to flow through the flow path of the extraction unit for each of the stages;
an outflow step of causing mixture fluid including the material fluid and the extractant to outflow from the flow path of the extraction unit for each of the stages before the extraction of the specific component from the material fluid reaches an extraction equilibrium in the flow path of the extraction unit for each of the stages;
a separation step of separating the mixture fluid outflowing from the flow path of the extraction unit for each of the stages into the material fluid and the extractant;
a material fluid supply step of supplying the material fluid that outflows from the flow path of the extraction unit for each of the stages and is separated in the separation step to the flow path of the extraction unit of the next stage; and
a pH adjustment step of adjusting a pH of the material fluid that outflows from the flow path of the extraction unit of a specific stage and is separated in the separation step so as to reverse a change in the pH of the material fluid caused by the extraction of the specific component in the extraction step before supplying the material fluid to the flow path of the extraction unit of the next stage”.

One characteristic of this method is that, in a case where the specific component is extracted from the material fluid to the extractant in order to improve the time efficiency of the extraction treatment, the mixture fluid including the material fluid and the extractant is caused to outflow from the flow path and separated before the extraction of the specific component reaches the extraction equilibrium.

### SUMMARY OF THE INVENTION

Incidentally, in the wet extraction method, in either case of a batch type or a flow type, for example, in order to reduce extraction costs and to realize industrialization, it is required to increase the amount of metal ions extracted to an oil phase to be used (which is the mass of metal ions extracted to the oil phase per unit volume; also referred to as the absolute amount of metal ions extracted). In addition, even in a case where the oil phase is reused to perform multiple extraction separation cycles, it is required to maintain a high extraction rate of metal ions to the oil phase (mass ratio of metal ion extracted to the oil phase to metal ions present in the water phase). In general, in the wet extraction method, in a case where an extraction condition varies, particularly extraction resolution (extraction selectivity) is likely to vary. Accordingly, in a case where it is attempted to suppress a variation in extraction conditions (extraction environment) such as an extraction temperature, it is necessary to provide a manufacturing facility such as a temperature control facility, and the workability also decreases. Therefore, in order to reduce extraction costs and realize industrialization, even under extraction conditions such as an extraction temperature, in particular, a low temperature condition, it is required to maintain high extraction resolution that is achieved under a temperature condition of normal temperature.

However, JP2016-019939A does not investigate the increase in the amount of metal ions extracted to the oil phase and the achievement of high extraction resolution under the low temperature condition.

An object of the present invention is to provide a method of extracting metal ions in which metal ions can be extracted to an oil phase in a large amount with high extraction resolution is maintained even under a low temperature condition while maintaining a high extraction rate even after multiple extraction separation cycles are performed.

The present inventors conceived a thought that, in a wet extraction method, in a case where an oil phase and a water phase are mixed through a flow type where an interfacial area between the oil phase and the water phase is large and a reaction field is small, a mixed state of the oil phase and the water phase can be improved even after increasing a content of an extractant in the oil phase. The present inventors continuously conducted a thorough investigation based on this thought and found that, in a flow type wet extraction method (flow type mixing method) in which an oil phase and a water phase are combined while flowing, are mixed, and are phase-separated, by reducing flow diameters of the oil phase and the water phase that are flowing before being combined, combining both the phases, and additionally causing the combined solution to flow while mixing both the phases preferably in a state where the pH is set to a predetermined pH, the amount of metal ions extracted to the oil phase can be improved, and high extraction resolution can be maintained in a low temperature condition. In addition, deterioration, decomposition, or the like of the extractant in the oil phase that is phase-separated from the water phase are suppressed, and even in a case where this oil phase is reused in the above-described flow type wet extraction method, a predetermined high extraction rate can be maintained over multiple times.

The present invention has been completed as a result of repeated investigation based on the above findings.

That is, the above-described objects have been achieved by the following means.

<1> A method of extracting metal ions in which a water phase including metal ions and an oil phase including an acidic extractant are combined to be mixed while flowing, subsequently the mixture is phase-separated into a water phase and an oil phase to extract the metal ions to the oil phase, and
a content of the acidic extractant in the oil phase that is caused to flow is 35% to 100% by volume, the method comprising:
a step of reducing a flow diameter of each of the water phase and the oil phase that are flowing, combining the water phase and the oil phase, and continuously causing a two-liquid combined solution to flow;
a step of combining the water phase, the oil phase, and a pH adjusting agent aqueous solution and additionally causing a three-liquid combined solution to flow; and
a step of phase-separating the three-liquid combined solution after extraction of metal ions to be extracted reaches an extraction equilibrium.

2> The method of extracting metal ions according to <1>,
in which in the additional flow step, the two-liquid combined solution of the water phase and the oil phase that are combined in the continuous flow step is combined with the pH adjusting agent aqueous solution, and the three-liquid combined solution is additionally caused to flow.

<3> The method of extracting metal ions according to <1>,
in which in the continuous flow step, the additional flow step is performed to combine the water phase, the oil phase, and the pH adjusting agent aqueous solution at a stroke, and a three-liquid combined solution is additionally caused to flow.

<4> The method of extracting metal ions according to any one of <1> to <3>,
in which in at least one of the continuous flow step or the additional flow step, the combined solution is caused to flow in a flow path where a static mixer is provided.

<5> The method of extracting metal ions according to any one of <1> to <4>,
in which the water phase and the oil phase are combined using collision of the respective phases that are flowing.

6 The method of extracting metal ions according to any one of <1> to <5>,
in which in a case where the water phase and the oil phase are combined, a reduction ratio between the flow diameters is 0.1 to 0.8.

<7> The method of extracting metal ions according to any one of <1> to <6>,
in which in a case where the water phase and the oil phase are combined using collision of the respective phases that are flowing, kinetic energy of the water phase and the oil phase per unit area and per unit time is 50 to 100000 J/sec/m².

<8> The method of extracting metal ions according to any one of <1> to <7>,
in which the three-liquid combined solution is left to stand to be phase-separated into the water phase and the oil phase.

<9>> The method of extracting metal ions according to any one of <1> to <8>,
in which the metal ions include plural kinds of metal ions, and at least one kind of metal ions among the plural kinds of metal ions is separated and extracted from other kinds of metal ions.

<10> The method of extracting metal ions according to any one of <1> to <9>,
in which multiple extraction separation cycles consisting of the continuous flow step, the additional flow step, and the phase separation step are performed, and
the oil phase that is phase-separated in the phase separation step is reused as an oil phase of a next extraction separation cycle.

<11> The method of extracting metal ions according to any one of <1> to <10>,
in which the acidic extractant includes a phosphoric acid-based compound.

<12> The method of extracting metal ions according to <11>,
in which the acidic extractant is represented by Formula (I),

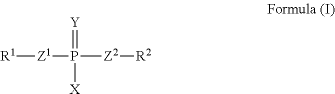

in Formula (I), R¹ and R² represent a substituent, in which at least one of R¹ or R² represents a hydrocarbon group having 9 or more carbon atoms, X represents —OH or —SH,
Y represents an oxygen atom or a sulfur atom, and Z¹ and Z² represent a single bond, —O—, —NH—, or —S—.

According to the present invention, it is possible to provide a method of extracting metal ions in which metal ions can be extracted to an oil phase in a large amount with high extraction resolution is maintained even under a low temperature condition while maintaining a high extraction rate even after multiple extraction separation cycles are performed.

The above-described and other characteristics and advantageous effects of the present invention will be clarified from the following description appropriately with reference to the accompanying drawings.

### BRIEF DESCRIPTION OF THE DRAWINGS

FIG. 1 is a schematic front view showing an example of an extraction device that is suitably used for a method of extracting metal ions according to the present invention.

FIG. 2 is a schematic front view showing another example of the extraction device that is suitably used for the method of extracting metal ions according to the present invention.

FIG. 3 is a diagram showing a modification example of a flow pipe used in an extraction device that is suitably used for the method of extracting metal ions according to the present invention.

FIG. 4 is a graph showing a relationship between the content of an acidic extractant in an oil phase in Example and an extraction rate in a 20th extraction separation cycle.

### DESCRIPTION OF THE PREFERRED EMBODIMENTS

In the present invention, in a case where a numerical range is shown to describe a content, physical properties, or the like of a component, any upper limit value and any lower limit value can be appropriately combined to obtain a specific numerical range in a case where an upper limit value and a lower limit value of the numerical range are described separately. In a case where a plurality of numerical ranges represented by “~” are set and described, the upper limit value and the lower limit value which form each of the numerical ranges are not limited to a specific combination of the upper limit value and the lower limit value described before and after “to” as a specific numerical range and can be set to a numerical range obtained by appropriately combining the upper limit value and the lower limit value of each numerical range. In the present invention, any numerical range indicated by using “to” means a range including the numerical values described before and after “to” as the lower limit value and the upper limit value, respectively.

In the present invention, an expression regarding a compound (for example, in a case where a compound is represented by an expression in which “compound” is attached to the end) is used to have a meaning including not only the compound itself but also a salt or an ion thereof. In addition, this expression also refers to a derivative obtained by modifying a part of the compound, for example, by introducing a substituent into the compound within a range where the effects of the present invention do not deteriorate.

A substituent, a linking group, or the like (hereinafter, referred to as “substituent or the like”) that is not specified in the present invention regarding whether to be substituted or unsubstituted may have an appropriate substituent. Accordingly, even in a case where a YYY group is simply described in the present invention, this YYY group includes not only an aspect not having a substituent but also an aspect having a substituent. The same shall be applied to a compound which is not specified in the present specification regarding whether to be substituted or unsubstituted. Examples of a preferable substituent include groups selected from a substituent G described below.

In the present invention, in a case where a plurality of substituents or the like represented by a specific reference numeral are present or a plurality of substituents or the like are simultaneously defined, the respective substituents or the like may be the same as or different from each other. In addition, unless specified otherwise, in a case where a plurality of substituents or the like are adjacent to each other, the substituents may be linked or fused to each other to form a ring.

In the present specification, “metal elements belonging to different groups in the periodic table of elements” will be referred to as “different-group metal elements”, and particularly “different-group metal elements of the same period in the periodic table” will also be referred to as “same-period different-group metal elements”. In addition, “ions of the different-group metal elements” and “ions of the same-period different-group metal elements” will also be referred to as “different-group metal ions” and “same-period different-group metal ions”, respectively.

In the present invention, unless specified otherwise, “ppm” representing a content or the like is based on mass and represents “mass ppm”.

A method of extracting metal ions according to an embodiment of the present invention is a flow type wet extraction method in which a water phase including metal ions and an oil phase including an acidic extractant are combined to be mixed while flowing, subsequently the mixture is phase-separated into a water phase and an oil phase to extract the metal ions to the oil phase by phase separation.

In the extraction method according to the embodiment of the present invention, by performing each of steps described below using the water phase and the oil phase described below in the flow type wet extraction method, metal ions present in the water phase can be moved (extracted) to the oil phase in a large amount with high extraction resolution even in a low temperature condition while maintaining a high extraction rate (also referred to as a recovery rate) even after multiple extraction separation cycles are performed.

The method of extracting metal ions according to the embodiment of the present invention (hereinafter, also referred to as the extraction method according to the embodiment of the present invention) will be described with reference to a device that is suitably used for the extraction method according to the embodiment of the present invention.

[Extraction Device that is Suitably Used for Extraction Method According to Embodiment of Present Invention]

The extraction device that is suitably used for the extraction method according to the embodiment of the present invention (hereinafter, also referred to as the extraction device suitable for the embodiment of the present invention) is not particularly limited, and includes, for example, a water phase flow pipe through which the water phase flows (is transported) to a combining portion, an oil phase flow pipe through which the oil phase flows (is transported) to the combining portion, the combining portion that is connected to a downstream side of the water phase flow pipe and the oil phase flow pipe in a flow direction, a mixing portion (mixing flow pipe) that extends from the combining portion, and a separation portion that is connected to a downstream side of the mixing portion in the flow direction.

Here, the water phase flow pipe, the oil phase flow pipe, and the mixing portion can be made to have the same configuration, arrangement, and the like as a water phase flow pipe, an oil phase flow pipe, and a mixing portion in an extraction device 1 or 2 described below. In this device, each of the steps of the extraction method according to the embodiment of the present invention can be suitably performed.

Hereinafter, the upstream side and the downstream side of the oil phase, the water phase, or a combined solution in the flow direction will also be simply referred to as the downstream side and the upstream side, respectively.

### <Extraction Device 1>

An extraction device 1 that is an example of the extraction device suitable for the embodiment of the present invention is suitable as a device that performs a step of mixing the water phase and the oil phase and continuously causing a two-liquid combined solution to flow and a step of combining the two-liquid combined solution with a pH adjusting agent aqueous solution and additionally causing a three-liquid combined solution to flow in this order.

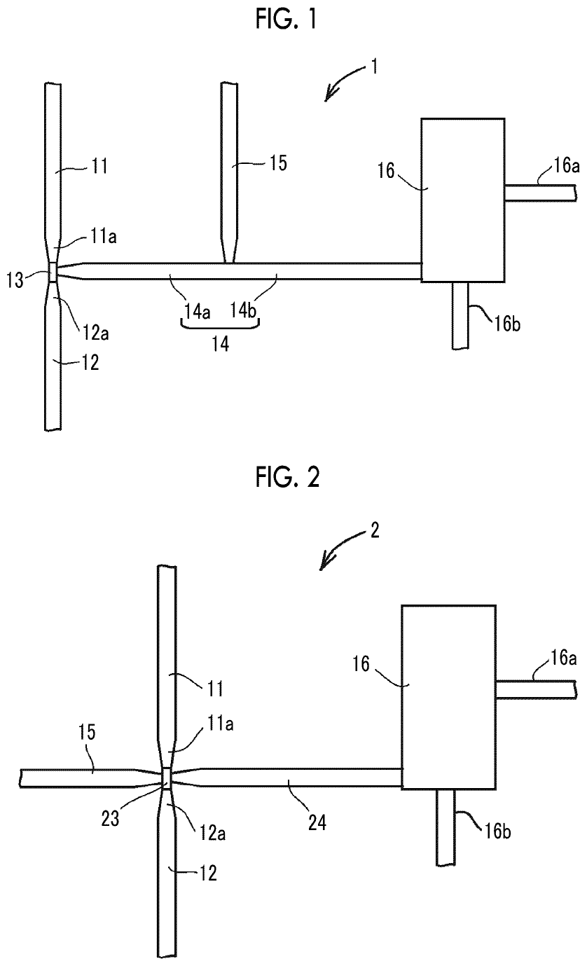

As shown in FIG. 1, the extraction device 1 includes a water phase flow pipe 11 through which the water phase flows to a combining portion and that has a tapered portion 11a on the downstream side in the flow direction of the water phase, and an oil phase flow pipe 12 through which the oil phase flows to the combining portion and that has a tapered portion 12a on the downstream side in the flow direction of the oil phase. The water phase flow pipe 11 and the oil phase flow pipe 12 are disposed to face each other on one straight line. A combining portion 13 that connects an opening end portion of the tapered portion 11a and an opening end portion of the tapered portion 12a to combine both the phases is provided. Here, in the water phase flow pipe 11 and the oil phase flow pipe 12, the inner diameters decrease toward the downstream side due to the tapered portions 11a and 12a, respectively. Due to the shape of each of the tapered portions, an opening diameter of the opening end portion of the tapered portion is less than (small diameter) an inner diameter of an upstream side opening end portion (a connection portion to a flow pipe having a given inner diameter) of the tapered portion. Cross sections of the flow pipes 11 and 12 and the tapered portions 11a and 12a perpendicular to a central line are not particularly limited and may have various shapes, for example, a circular shape, an elliptical shape, a semi-circular shape, or a polygonal shape. The given inner diameter of each of the flow pipes 11 and 12 (the inner diameter of the upstream side opening end portion of the tapered portion) is not particularly limited and is appropriately determined. For example, the inner diameter can be made to be 0.1 to 100 mm and, from the viewpoint of improving the mixed state, is preferably 0.5 to 10 mm. Flow diameters (inflow diameters) of the water phase and the oil phase flowing from the flow pipes 11 and 12 to the combining portion 13 are reduced to be less than flow diameters of the water phase and the oil phase flowing through the flow pipes 11 and 12 by the tapered portions 11a and 12a. In this case, a ratio of the inner diameter of the opening end portion of the tapered portion to the given diameter of each of the flow pipes 11 and 12 (the inner diameter of the opening end portion of the tapered portion/the given inner diameter of the flow pipe: the inner diameter of the connection portion to the tapered portion) is not particularly limited, is appropriately determined depending on a flow velocity or the like, and is preferably the same as a reduction ratio between the flow diameters of both the phases described below. The inner diameters of the water phase flow pipe 11 and the oil phase flow pipe 12 may be different from each other, but are preferably set to be the same. In addition, the inner diameter of the opening end portion of the tapered portion 11a and the inner diameter of the opening end portion of the tapered portion 12a, and further the inner diameter reduction rate (the above described ratio between the inner diameters) of the tapered portion 11a and the inner diameter reduction rate of the tapered portion 12a may be different from each other, but are typically set to be the same in consideration of the mixed state and the like. In the present invention, the inner diameter refers to an equivalent diameter, and will be described below in detail.

The extraction device 1 includes a tubular mixing portion 14 that extends from the combining portion 13 in a direction substantially at the right angle to the water phase flow pipe 11, and a pH adjusting agent transport pipe 15 through which the pH adjusting agent aqueous solution is transported is connected to an intermediate portion of the mixing portion 14. The mixing portion 14 includes an inverse tapered portion where the inner diameter gradually increases toward the downstream side from the connection portion to the combining portion 13. A dimension or the like of the inverse tapered portion is not particularly limited, can be appropriately set, and, for example, can be set to be the same as the reduction ratio between the flow diameters of both the phases described below. The extraction device 1 includes a separation portion 16 that is connected to a downstream side end portion of the mixing portion 14 in the flow direction such that the three-liquid combined solution flowing therein is left to stand to be phase-separated into a water phase and an oil phase.

In the mixing portion 14, a portion from the connection portion to the combining portion 13 to a connection position to the pH adjusting agent transport pipe 15 will be referred to as a front-stage mixing portion 14a, and a portion from the connection position to the pH adjusting agent transport pipe 15 to a connection position to the separation portion 16 will be referred to as a rear-stage mixing portion 14b.

In addition, the separation portion 16 can be configured with a general storage container, a separation tower, a mixer, a settler, a separating funnel, or the like, and includes an oil phase discharge pipe 16a through which the phase-separated oil phase is discharged and a water phase discharge pipe 16b through which the phase-separated water phase is discharged. Each of the oil phase discharge pipe 16a and the water phase discharge pipe 16b is equipped with valves and transport means, for example, various pumps.

In the extraction device 1, it is preferable that a static mixer is provided in a flow path of at least one of the front-stage mixing portion 14a and the rear-stage mixing portion 14b in the mixing portion 14, and it is more preferable that the static mixer is provided in the flow path of the rear-stage mixing portion 14b from the viewpoint of further improving the mixed state of the three-liquid combined solution.

The static mixer is a stationary mixer without a driving portion, which stirs and mixes together fluids introduced into the mixer while sequentially repeating division, re-combining, and direction changing by using a stationary mixing element installed in the mixer. Examples of the static mixer include a Sulzer static mixer, a Kenics static mixer, a Toray's static mixer, and a static mixers from NORITAKE CO., LIMITED. The static mixer preferably has 4 or more mixing elements, and more preferably has 6 to 30 mixing elements. It is preferable that these mixing elements are arranged consecutively in a mixer pipe having a length of 10 cm to 2 m. In addition, a configuration in which a plurality of static mixers having the above-described configuration are arranged in series. In this case, all of the plurality of static mixers arranged in series form a single unit, which is the static mixer according to the embodiment of the present invention.

The size of the static mixer used in the present invention is appropriately set according to the manufacturing scale and the like. For example, an inner equivalent diameter of the pipe of the static mixer can be 1 to 100 mm. Even in a case where an inner cross section of the static mixer is larger than an inner cross section of the flow pipe, the flow pipe and the static mixer can be linked through a tube or the like capable of connecting the static mixer and the flow pipe.

A length of the static mixer can be about 5 mm to 20 mm. In a case where a plurality of static mixers are arranged in series, the above-described length is the total length of the plurality of static mixers arranged in series (including the distance between the static mixers). In addition, in a case where a plurality of static mixers are arranged in series, the distance between adjacent static mixers can be appropriately set in consideration of a difference between a size of an inner cross section of the static mixer and a size of an inner cross section of a reaction flow path connected to the static mixer, and the like. The distance between adjacent static mixers can be, for example, 100 cm or less, 70 cm or less, 40 cm or less, 20 cm or less, or 10 cm or less.

Examples of the material of the static mixer include perfluoroalkoxy alkane (PFA), Teflon (registered trademark), an aromatic polyether ketone-based resin, stainless steel, copper or a copper alloy, nickel or a nickel alloy, titanium or a titanium alloy, quartz glass, and soda lime glass. From the viewpoint of flexibility, chemical resistance, and the like, PFA (registered trademark), Teflon, stainless steel, a nickel alloy, or titanium is preferable.

In the extraction device 1, for the water phase flow pipe 11, the oil phase flow pipe 12, and the mixing portion 14, a three-way pipe having (formed) the tapered portions 11a and 12a, for example, a T pipe or an Y pipe can be used.

In the extraction device 1, the water phase flow pipe 11, the oil phase flow pipe 12, the combining portion 13, and the front-stage mixing portion 14a will be referred to as “oil-water mixing portion”, and the pH adjusting agent transport pipe 15 and the rear-stage mixing portion 14b will also be referred to as “pH adjusting portion”.

### <Extraction Device 2>

An extraction device 2 according to another example of the extraction device suitable for the embodiment of the present invention is a device that can perform, in one step, a step of combining the two-liquid combined solution with a pH adjusting agent aqueous solution and additionally causing a three-liquid combined solution to flow in the step of mixing the water phase and the oil phase and continuously causing a two-liquid combined solution to flow. The extraction device 2 is suitable as a device that performs a step of combining the water phase, the oil phase, and the pH adjusting agent aqueous solution at a stroke and additionally causing a three-liquid combined solution to flow. This extraction device 2 has basically the same configuration as the extraction device 1, except that a pH adjusting agent aqueous solution transport pipe 15 is connected to a combining portion 23.

As shown in FIG. 2, the extraction device 2 includes a water phase flow pipe 11 through which the water phase flows to a combining portion and that has a tapered portion 11a on the downstream side in the flow direction of the water phase, an oil phase flow pipe 12 through which the oil phase flows to the combining portion and that has a tapered portion 12a on the downstream side in the flow direction of the water phase, and a pH adjusting agent transport pipe 15 through which the pH adjusting agent aqueous solution is transported to the combining portion, in which the pH adjusting agent transport pipe 15 is disposed at an angle of the substantially right angle to the water phase flow pipe 11 and the oil phase flow pipe 12 that are disposed on the same line. The pH adjusting agent transport pipe 15 has a tapered portion toward the downstream side in the flow direction. A combining portion 23 that connects an opening end portion of the tapered portion 11a, an opening end portion of the tapered portion 12a, and an opening end portion of the pH adjusting agent transport pipe 15 to combine the water phase, the oil phase, and the pH adjusting agent aqueous solution is provided. Here, the water phase flow pipe 11 and the oil phase flow pipe 12 are the same as the water phase flow pipe 11 and the oil phase flow pipe 12 of the extraction device 1. For example, in the water phase flow pipe 11 and the oil phase flow pipe 12, the inner diameters decrease toward the downstream side due to the tapered portions 11a and 12a, respectively. Due to the shape of each of the tapered portions, an opening diameter of the opening end portion of the tapered portion is less than an inner diameter of an upstream side opening end portion (a connection portion to a flow pipe having a given inner diameter) of the tapered portion. Flow diameters (inflow diameters) of the water phase and the oil phase flowing from the flow pipes 11 and 12 to the combining portion 23 are reduced to be less than flow diameters of the water phase and the oil phase flowing through the flow pipes 11 and 12 by the tapered portions 11a and 12a. In this case, a ratio of the inner diameter of the opening end portion of the tapered portion to the given diameter of each of the flow pipes 11 and 12 (the inner diameter of the opening end portion of the tapered portion/the given inner diameter of the flow pipe: the inner diameter of the connection portion to the tapered portion) is not particularly limited, is appropriately determined depending on a flow velocity or the like, and is preferably the same as a reduction ratio between the flow diameters of both the phases described below.

The extraction device 2 includes a mixing portion 24 that extends from the combining portion 23 on an extension line of the pH adjusting agent transport pipe 15 in the flow direction. The mixing portion 24 includes an inverse tapered portion where the inner diameter gradually increases toward the downstream side in the flow direction from the connection portion to the combining portion 23. The extraction device 2 includes a separation portion 16 that is connected to a downstream side end portion of the mixing portion 24 in the flow direction such that the combined solution flowing therein is left to stand to be phase-separated into a water phase and an oil phase. The separation portion 16 has the same configuration as the separation portion 16 of the extraction device 1.

In the extraction device 2, it is preferable that a static mixer is provided in the flow path of the mixing portion 24 from the viewpoint of highly improving the mixed state of the three-liquid combined solution. The static mixer is as described above in the extraction device 1.

In the extraction device 2, for the water phase flow pipe 11, the oil phase flow pipe 12, the pH adjusting agent transport pipe 15, and the mixing portion 24, a four-way pipe having (formed) the tapered portions 11a and 12a, for example, a cross pipe can be used.

This extraction device 2 is preferable from the viewpoint of reducing the flow path length of the mixing portion 24.

In the extraction device 2, the configurations of the water phase flow pipe 11, the oil phase flow pipe 12, the pH adjusting agent transport pipe 15, the combining portion 23, and the mixing portion 24 also function as “oil-water mixing portion” and “pH adjusting portion” of the extraction device 1, and will also be referred to as “oil-water mixing pH adjusting portion”.

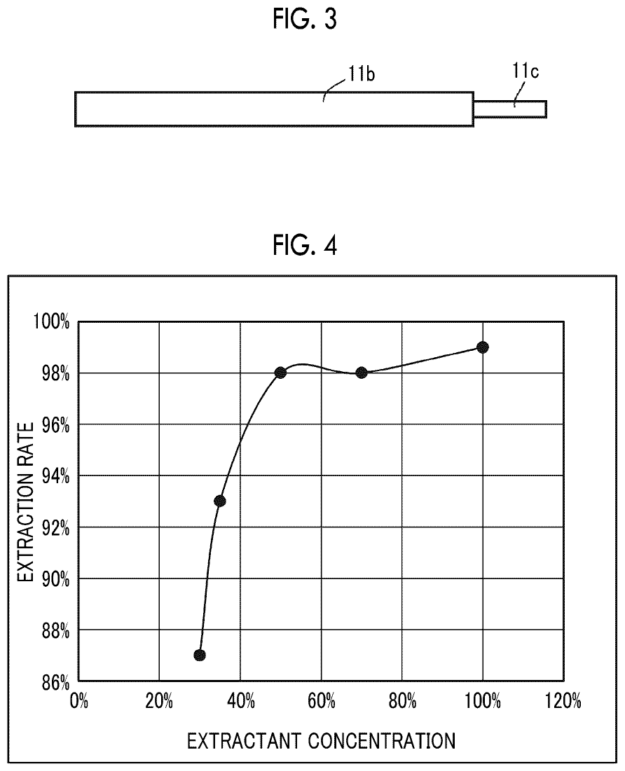

In both the extraction devices 1 and 2, the water phase flow pipe 11 and the oil phase flow pipe 12 are configured such that the inner diameter decreases (is reduced) toward the downstream side due to the tapered portions 11a and 12a. In the extraction device suitable for the embodiment of the present invention, the water phase flow pipe and the oil phase flow pipe are not limited to the structure having the tapered portion. For example, as shown in FIG. 3, a pipe where a large-diameter portion 11b and a small-diameter portion 11c are connected can be used.

In addition, in the extraction devices 1 and 2, each of the flow pipe that is connected to the combining portion 13 or 23 is disposed at an angle of substantially the right angle. In the extraction device suitable for the embodiment of the present invention, the angle of the pipe connected to the combining portion is not particularly limited. For example, the water phase flow pipe and the oil phase flow pipe can also be configured using a double pipe or a pipe having two inner flow paths. In this case, the arrangement of both the pipes are parallel to each other, and a combining angle of the water phase and the oil phase that are flowing decreases to substantially 0°. In the extraction method according to the embodiment of the present invention, the arrangement angle between the water phase flow pipe and the oil phase flow pipe (the combining angle between the water phase and the oil phase) is preferably set to a certain angle from the viewpoint that the mixed state can be improved by collision generated by the combining of both the phases the same as the combining angle described below. Specifically, the arrangement angle is the same as the combining angle described below.

### [Fluid Used in Extraction Method According to Embodiment of Present Invention]

In the extraction method according to the embodiment of the present invention, fluids of the water phase, the oil phase, and the pH adjusting agent aqueous solution are prepared.

### <Water Phase>

Water formed in the water phase is not particularly limited, and (super) pure water, ion exchange water, or the like can be used.

In the present invention, the number of kinds of metal ions in the water phase may be one and is preferably at least two.

The metal ions in the water phase may include metal ions of metal elements belonging to Group 1 to Group 14 in the periodic table, preferably includes metal ions belonging to Group 3 to Group 14, and may include metal ions belonging to Group 15 to Group 17.

In the present invention, it is preferable that two or more kinds of metal ions belonging to Group 1 to Group 14 are included, it is more preferable that two or more kinds of metal ions belonging to Group 3 to Group 14 are included, and it is still more preferable that ions of at least one kind of a transition metal element (transition metal element belonging to Group 3 to Group 12) are included. In an aspect including at least one transition metal element, it is preferable that two or more kinds of metal ions belonging to Group 4 to Group 12 are included, it is more preferable that two or more kinds of metal ions belonging to Group 4 to Group 12 are included, it is still more preferable that two or more kinds of metal ions belonging to Group 8 to Group 12 are included, it is still more preferable that two or more kinds of metal ions belonging to Group 9 to Group 12 are included, and it is most preferable that two or more kinds of metal ions belonging to Group 9 and Group 10 are included. The metal ions belonging to each of the groups are not particularly limited, metal ions belonging to the fourth to sixth periods in the periodic table are preferable, and metal ions belonging to the fourth period or the fifth period are more preferable. In addition, the number of kinds of the metal ions is not particularly limited as long as it is 2 or more. For example, the number of kinds of the metal ions can be 2 to 15 and is preferably 2 to 8 and more preferably 2 to 5.

A combination of the plurality of metal ions is not particularly limited, and examples of the combination of groups include a combination including Group 9 and Group 10, a combination including Group 9 and Group 12, a combination including Group 9 and Group 11, a combination including Group 9, Group 10, and Group 12, a combination including Group 4 and Group 9, a combination including Group 7, Group 9, and Group 10, and a combination including Group 7, Group 8, Group 9, and Group 10.

In the present invention, the number of kinds of metal ions belonging to each of the groups may be two or more but, from the viewpoint of exhibiting high selectivity, is preferably one.

Specific examples of the combination of the metal ions include a combination including Co and Ni, a combination including Co and Zn, a combination including Co and Cu, a combination including Rh and Ni, a combination including Zr and Rh, a combination including Mn, Co, and Ni and a combination including Mn, Fe, Co, and Ni.

The plural kinds of metal ions in the water phase may include the same group of metal ions, or may include different-group metal ions. The number of kinds of the different-group metal ions in the water phase may be 2 or more and, for example, is preferably 2 to 4 and more preferably 2.

The metal element belonging to each of the groups is not particularly limited, and an appropriate atom can be used. Examples of the metal element belonging to each of the groups are as follows.

Preferable examples of a metal element belonging to Group 1 include Li, Na, Rb, and Cs.

Preferable examples of a metal element belonging to Group 2 include Mg, Ca, Sr, and Ba.

Preferable examples of a metal element belonging to Group 3 include Sc and Y.

Preferable examples of a metal element belonging to Group 4 include Ti, Zr, and Hf.

Preferable examples of a metal element belonging to Group 5 include V, Nb, and Ta.

Preferable examples of a metal element belonging to Group 6 include Cr, Mo, and W.

Preferable examples of a metal element belonging to Group 7 include Mn and Tc.

Preferable examples of a metal element belonging to Group 8 include Fe, Ru, and Os.

Preferable examples of a metal element belonging to Group 9 include Co, Rh, and Ir.

Preferable examples of a metal element belonging to Group 10 include Ni, Pd, and Pt.

Preferable examples of a metal element belonging to Group 11 include Cu, Ag, and Au.

Preferable examples of a metal element belonging to Group 12 include Zn, Cd, and Hg.

Preferable examples of a metal element belonging to Group 13 include Al, Ga, In, and Tl.

Preferable examples of a metal element belonging to Group 14 include Ga, Sn, and Pb.

Preferable examples of a metal element belonging to Group 15 include Sb and Bi.

A metal element belonging to Group 16 is not particularly limited, and preferable examples thereof include Te.

The metal ions can be appropriately prepared and, for example, various metal salts (salts of typical elements with inorganic acids such as nitric acid or sulfuric acid or organic acids such as acetic acid), a mixture of mined metals (ion), a recovery from metal waste, other waste such as a metal recovery from a waste battery (LiB), or a mixture thereof can be used. Examples of the metal recovery from the waste LiB include recoveries obtained using a well-known method such as a wet process or electrolysis.

A total content of the metal ions in the water phase is not particularly limited and is appropriately set. For example, the total content can be 1000 to 1000000 mass ppm and is preferably 1000 to 100000 mass ppm and more preferably 1000 to 80000 mass ppm. In particular, in the extraction method according to the embodiment of the present invention, while realizing metal ions extracted in a large amount, the total content of metal ions in the water phase can be set to be high.

A total content of the metal ions belonging to Groups 9 to 12 among the metal ions is not particularly limited and is appropriately set. For example, the content can be 1000 to 80000 mass ppm and is preferably 1000 to 50000 mass ppm.

A total content of the metal ions belonging to Group 3 to Group 7 and Group 13 to Group 16 among the metal ions is not particularly limited and is appropriately set. For example, the total content can be 1000 to 60000 mass ppm and is preferably 1000 to 30000 mass ppm.

A content of the metal ions belonging to each of the groups is not particularly limited and is appropriately set. For example, the content can be 1000 to 60000 mass ppm and is preferably 1000 to 50000 mass ppm. In a case where two or more kinds of metal ions belonging to each of the groups are present, the content of the metal ions belonging to each of the groups is the total content.

In the present invention, in a case where the water phase includes different-group metal ions, the content of the metal ions belonging to one group may be more than or less than a content of the metal ions belonging to another group. In the extraction method according to the embodiment of the present invention, in a case where the water phase includes different-group metal ions, the metal ions can be separated and recovered with high selectivity. Therefore, the contents of the metal ions belonging to different groups do not need to be set at a specific ratio. For example, a mass ratio of the content of metal ions belonging to a specific group (for example, metal ions extracted in the maximum amount) to the content of metal ions belonging to another group (for example, metal ions other than the metal ions extracted in the maximum amount (including metal ions that are not extracted) [the content of the metal ions belonging to the specific group: the content of the metal ions belonging to the other group] can be, for example, 100:1 to 10000 and is preferably 100:10 to 5000, and more preferably 100:50 to 1000.

The pH of the water phase is not particularly limited and is appropriately set. For example, the pH of the water phase is preferably 0.1 to 10 and more preferably 2.0 to 9.0 in consideration of the solubility of the metal ions, the formation of complex ions, and the like.

The pH of the water phase can be adjusted, for example, using an acid or an alkali. As the acid, a well-known acid can be used without any particular limitation, and examples thereof include an inorganic acid such as sulfuric acid, hydrochloric acid, nitric acid, or phosphoric acid and an organic acid such as formic acid, acetic acid, oxalic acid, organic phosphoric acid, or organic sulfonic acid. As the alkali, a well-known alkali can be used without any particular limitation, and examples thereof include an inorganic alkali and an organic alkali. Among these, an inorganic alkali is preferable. Examples of the inorganic alkali include a hydroxide of a metal belonging to Group 1 or Group 2, a metal alkali such as a carbonate, ammonia water, and ammonium chloride. Examples of the organic alkali include an organic ammonium salt.

The temperature of the water phase is not particularly limited and can be, for example, 10° C. to 60° C. It is preferable that the water phase used in the extraction method according to the embodiment of the present invention that is performed under a low temperature condition is set to a low temperature condition described below.

A density (kg/m³, 25° C.) of the water phase is not particularly limited, and cannot be uniquely determined based on the content of metal ions and the like. For example, the density of the water phase is preferably 900 to 2000 kg/m³ from the view point that kinetic energy EST described below is likely to be set to a suitable value such that the amount of metal ions extracted, the maintenance (also referred to as durability) of a high extraction rate even after multiple extraction separation cycles, and the extraction resolution (unless specified otherwise, refer to room-temperature resolution and low-temperature resolution; hereinafter the same applies) can be improved.

The water phase may optionally include, for example, a ligand coordinated to metal ions or a compound that generates the ligand.

The water phase can be prepared by dissolving metal ions in water. Preparation conditions of the water phase are not particularly limited. For example, the preparation temperature can be typically 10° C. to 60° C., and can be set to a low temperature condition described below in consideration of the solubility of metal ions and the like.

The water phase may include a masking agent in addition to the above-described metal ions. As the masking agent, various well-known agents can be used without any particular limitation. Examples of the masking agent include a monodentate ligand such as ammonia or a chelating agent such as dithizone.

In the extraction method according to the embodiment of the present invention, the acidic extractant alone can be coordinated to metal ions to extract the metal ion to the oil phase. Therefore, the water phase and the oil phase do not need to include a compound that acts to extract metal ions in cooperation with the acidic extractant, such as, a compound that is coordinated to metal ions or a compound that forms a ligand. For example, the water phase and the oil phase do not need to include a well-known acidic extractant. In the extraction method according to the embodiment of the present invention, typically, the water phase including the specific metal ions as an essential component and the oil phase including the acidic extractant as an essential component are used.

### <Oil Phase>

In the extraction method according to the embodiment of the present invention, the oil phase (organic phase) including one kind or two or more kinds of acidic extractants is used.

The oil phase may include an organic solvent. The organic solvent that may be included in the oil phase is not particularly limited, and an appropriate organic solvent can be used. Examples of the organic solvent include an alcohol solvent, an ether solvent, a hydrocarbon-based solvent (an aromatic solvent or an aliphatic solvent), and a halogen solvent. In particular, a hydrocarbon-based solvent is preferable, various solvents as components separated from petroleum are more preferable, and hydrocarbon-based solvents of aromatic groups, paraffin, naphthene, kerosine, gasoline, naphtha, heating oil, and light oil are still more preferable.

The acidic extractant according to the embodiment of the present invention is not particularly limited as long as it exhibits solubility in an organic solvent, is present in the oil phase, is coordinate-bonded to metal ions present in the vicinity of an interface between the water phase and the oil phase, and has a function of moving the metal ions to the oil phase. The acidic extractant can be appropriately selected and used from various well-known metal extractants. In addition, from the viewpoint that a large amount of metal ions extracted can be obtained and, while maintaining a high extraction rate, high extraction resolution can be maintained under a low temperature condition even after multiple extraction separation cycles are performed, as the acidic extractant, an acidic extractant selected from a phosphoric acid-based compound is preferable, a compound represented by Formula (I) below is more preferable. In the present invention, the solubility in the organic solvent refers to a property in which the acidic extractant is soluble in the organic solvent in a content described below.

The acidic extractant will be described below.

The content of the acidic extractant in the oil phase is determined in consideration of the content of the metal ions, the amount of coordination to the metal ions, and the like. In the present invention that adopts the flow type mixing method, the content of the acidic extractant according to the embodiment of the present invention can be set to be high, specifically, 35% to 100% by volume. Therefore, in the oil phase, the interaction between the acidic extractants can be strengthened. Thus, according to the present invention, the amount of metal ions extracted can be increased, and deterioration and decomposition of the acidic extractant caused by the pH adjusting agent can be suppressed. Further, a change in the viscosity of the oil phase depending on temperature can be reduced, or a change in the contact frequency between the acidic extractant and the metal ions depending on temperature can be suppressed. Therefore, a variation in the amount of metal ions extracted and the extraction rate depending on operating temperature can be suppressed.

In the present invention, from the viewpoint that the amount of metal ions extracted, the durability, and the extraction resolution can be further improved, the content of the acidic extractant in the oil phase is preferably 40% by volume or more, more preferably 50% by volume or more, still more preferably 60% by volume or more, and still more preferably 70% by volume or more. The upper limit of the content of the acidic extractant can also be 100% by volume and, from the viewpoint of improving the low-temperature resolution, can be 80% by volume or less.

The temperature of the oil phase is not particularly limited and can be, for example, 10° C. to 60° C. It is preferable that the oil phase used in the extraction method according to the embodiment of the present invention that is performed under a low temperature condition is set to a low temperature condition described below.

A density (kg/m³, 25° C.) of the oil phase is not particularly limited, and cannot be uniquely determined based on the kind of the organic solvent, the kind or content of the acidic extractant, and the like. For example, the density of the oil phase is preferably 500 to 1500 kg/m³ from the viewpoint that the kinetic energy Est described below is likely to be set to a suitable value such that the amount of metal ions extracted, the durability, and the extraction resolution can be further improved.

The oil phase is used as the acidic extractant (that is liquid in an use environment) without any change or as a solution of an organic solvent. The oil phase as the solution of the acidic extractant can be prepared by dissolving the acidic metal extractant in the organic solvent. Preparation conditions of the oil phase are not particularly limited. For example, the preparation temperature can be typically 10° C. to 60° C., and can be set to a low temperature condition described below in consideration of the solubility of metal ions and the like.

### <pH Adjusting Agent Aqueous Solution>

Water formed in the pH adjusting agent aqueous solution is not particularly limited, and (super) pure water, ion exchange water, or the like can be used.

Examples of the pH adjusting agent in the pH adjusting agent aqueous solution include the acids and the alkalis that can be used for adjusting the pH of the water phase. Among these, the inorganic acid and the inorganic alkali are preferable, and hydrochloric acid or an aqueous hydrochloric acid solution, and an alkali hydroxide (hydroxide of a Group 1 element) is more preferable.

The content of the pH adjusting agent in the pH adjusting agent aqueous solution is appropriately set, and is determined to obtain a predetermined pH.

The temperature of the pH adjusting agent aqueous solution is not particularly limited and can be, for example, 10° C. to 60° C. It is preferable that the pH adjusting agent aqueous solution used in the extraction method according to the embodiment of the present invention that is performed under a low temperature condition is set to a low temperature condition described below.

The pH adjusting agent aqueous solution can be prepared by dissolving a pH adjusting agent in water. Preparation conditions of the pH adjusting agent aqueous solution are not particularly limited. For example, the preparation temperature can be typically 10° C. to 60° C., and can be set to a low temperature condition described below in consideration of the solubility of metal ions and the like.

### [Extraction Method According to Embodiment of Present Invention]

The extraction method according to the embodiment of the present invention is a flow type wet extraction method in which the water phase including metal ions, the oil phase where the content (concentration) of the acidic extractant is 35% to 100% by volume, and the pH adjusting agent aqueous solution are used, and includes at least the following steps 1 to 3.
Step 1: a step of reducing a flow diameter of each of the water phase and the oil phase that are flowing, combining the water phase and the oil phase, and continuously causing a two-liquid combined solution to flow
Step 2: a step of combining the water phase, the oil phase, and a pH adjusting agent aqueous solution and additionally causing a three-liquid combined solution to flow
Step 3: a step of phase-separating the three-liquid combined solution after extraction of metal ions to be extracted reaches an extraction equilibrium

In the extraction method according to the embodiment of the present invention including the steps 1 to 3, specific metal ions to which the acidic extractant is coordinated can be moved (extracted) from the water phase to the oil phase in a large amount with high extraction resolution even in a low temperature condition while maintaining a high extraction rate (also referred to as a recovery rate) even after multiple extraction separation cycles are performed.

In the extraction method according to the embodiment of the present invention, in a case where the metal ions in the water phase are one kind of metal ions, the metal ions to be extracted to the oil phase are these metal ions. On the other hand, in a case where the metal ions in the water phase are plural kinds of metal ions, the metal ions to be extracted to the oil phase are ideally the one specific kind of metal ions, but may be two or more kinds of metal ions or all kinds of metal ions. Here, metal ions that are extracted to the oil phase in a large amount with a high extraction rate and high extraction resolution (in the present invention, also referred to as the metal ions to be extracted) are at least one kind of metal ions (some kinds instead of all kinds) among plural kinds of metal ions (groups). For example, as ions of valuable metal elements, two or more kinds of different-group metal ions, for example, two or more kinds of metal ions belonging to Group 1 to Group 14 in the periodic table (preferably Group 4 to Group 12 in the periodic table, more preferably Group 9 to Group 12 in the periodic table, and still more preferably Group 8 to Group 11), desirably one kind of metal ions among cobalt ions and nickel ions that are the same-period different-group metal ions, or one kind of metal ions among manganese ions, cobalt ions, and nickel ions that are the same-period different-group metal ions can be extracted to the oil phase in a large amount with a high extraction rate and high extraction resolution.

It was found that the extraction method according to the embodiment of the present invention has the characteristics and function in which, although two or more kinds of metal ions among plural kinds of metal ions (groups) present in the water phase can be extracted to the oil phase at once, one kind of metal ions among the plural kinds of metal ions can be extracted to the oil phase in a large amount with a high extraction rate and high extraction resolution, thereby completing the extraction method according to the embodiment of the present invention. In particular, the extraction method according to the embodiment of the present invention is applicable to the new use where two or more kinds of metal ions, in particular, different-group metal ions are separated and recovered.

Since the same-period different-group metal ions have similar physical behaviors and similar chemical behaviors, it is not easy to separate and recover any one kind of metal ions among the same-period different-group metal ions in a large amount with a high extraction rate and high extraction resolution. However, in the extraction method according to the embodiment of the present invention, while extracting the same-period different-group metal ions having similar physical behaviors and similar chemical behaviors, in particular, metal ions belonging to Group 9 (in particular, cobalt ions) and metal ions belonging to Group 10 (in particular, nickel ions) that are required along with the recent rapid spread of lithium ion batteries, one kind of metal ions among the plural kinds of metal ions can be recovered in a large amount with a high extraction rate and high extraction resolution. In addition, likewise, while extracting metal ions (in particular, manganese ions) belonging to Group 7 and metal ions (in particular, cobalt ions) belonging to Group 9, one kind of metal ions among the plural kinds of metal ions can be recovered in a large amount with a high extraction rate and high extraction resolution. Therefore, the present invention can largely contribute to further spread of electric vehicles and construction of a sustainable society.

In the present invention, being capable of extracting (also referred to as recovering) metal ions in a large amount represents that the mass of metal ions extracted to the oil phase per unit volume among the metal ions in the water phase is large. The amount of metal ions extracted is not uniquely determined based on the content of the metal ions present in the water phase, the content of the acidic extractant in the oil phase, and the like. For example, regarding the metal ions (specific metal ions to be extracted) extracted in the maximum amount among the extracted metal ions, the content (concentration) of the metal ions in the oil phase is 25000 ppm or more and preferably 30000 ppm or more under a condition of Examples described below (a case where a metal ion-containing aqueous solution W3 or W4 was used). The upper limit is not particularly limited and is, for example, 50000 ppm or less and is 36000 ppm under the condition of Examples described below. In this case, the extraction rate is not particularly limited and, for example, is preferably 70% or more.

In addition, in the present invention, being capable of extracting metal ions with a high extraction rate represents that, regarding the metal ions extracted in the maximum amount among the metal ions extracted in the initial extraction separation cycle (Steps 1 to 3), a ratio of the amount of the metal ion extracted to the oil phase to the content of the metal ions (before the extraction) in the water phase [(the amount of the metal ions extracted to the oil phase)/(the content of the metal ions in the water phase) is preferably 90% or more under a condition of Examples below (a case where 20 cycles were performed using a metal ion-containing aqueous solution W1 or W2). The ratio (extraction rate) is more preferably 95% or more and still more preferably 98% or more. The upper limit is not particularly limited and is ideally the total amount (100%) of the metal ions present in the water phase. For example, the upper limit is preferably 99% or less and can also be 95% or less.

In the extraction method according to the embodiment of the present invention, in a case where the series of extraction separation cycles of the steps 1 to 3 are performed in multiple cycles, the extraction rate after the multiple cycles is maintained without a significant decrease from the initial extraction rate. For example, under a condition of Examples below (a case where the metal ion-containing aqueous solution W1 or W2 was used), the extraction rate (the above-described ratio) after multiple cycles is maintained at the high extraction rate in the initial extraction separation cycle, and is preferably 85% or more, more preferably 90% or more, and still more preferably 95% or more. The upper limit is ideally the total amount (100%) and can be, for example, 98% or less.

In the extraction method according to the embodiment of the present invention, in a case where the series of extraction separation cycles of the steps 1 to 3 are performed in multiple cycles, a difference between the extraction rate in the initial extraction separation cycle and the extraction rate after multiple extraction separation cycles [(the extraction rate in the initial extraction separation cycle)-(the extraction rate after multiple extraction separation cycles)] is an evaluation index for durability, and is preferably 12% or less, more preferably 8% or less, and still more preferably 4% or less. The lower limit is ideally 0% and can be, for example, 1%.

Further, in the present invention, being capable of extracting metal ions with high extraction resolution (high selectivity) represents that only one specific kind of metal ions among the metal ions present in the water phase can be selectively extracted. In addition, in a case where two or more kinds of metal ions are extracted to the oil phase, being capable of extracting metal ions with high selectivity represents that specific metal ions can be extracted and separated from the other metal ions such that, among the two or more kinds of extracted metal ions, a ratio of the amount of specific metal ions (typically one kind) to be extracted to the total amount of the other metal ions extracted [(the amount of the specific metal ions extracted)/(the total amount of the other metal ions extracted) is 2.0 or more under a condition of Examples below (a case where the metal ion-containing aqueous solution W1 or W2 was used) at a temperature of a normal temperature. The ratio (selection ratio) is preferably 4.0 or more, more preferably 5.0 or more, and still more preferably 6.0 or more. The upper limit thereof is not particularly limited, but can be, for example, 20.

In the present invention, maintaining high extraction resolution under a low temperature condition represents that the high extraction resolution that is achieved under a temperature condition of normal temperature is maintained. For example, under a condition of Examples below (a case where the metal ion-containing aqueous solution W1 or W2 was used) at a temperature of 5° C., the ratio [(the amount of the specific metal ions extracted)/(the total amount of the other metal ions extracted) is preferably 2.0 or more, more preferably 3.0 or more, and still more preferably 4.0 or more. The upper limit is not particularly limited and, for example, can be 20, for example, 15 or less.

In the present invention, the normal temperature refers to a temperature in a normal temperature environment. Specifically, the normal temperature is, for example, a temperature range of 15° C. to 60° C. and generally a temperature range of 20° C. to 30° C. The low temperature condition is not particularly limited and refers to, for example, a temperature lower than 15° C. Specifically, in consideration of an actual operating environment, the low temperature condition is preferably 0° C. to 10° C. and more preferably 5° C. to 10° C.

The extraction method according to the embodiment of the present invention can be suitably performed using the extraction device suitable for the embodiment of the present invention.

Hereinafter, the extraction method according to the embodiment of the present invention will be described in detail with reference to the extraction device 1 shown in FIG. 1.

### <Step 1>

In the extraction method according to the embodiment of the present invention, the following step 1 is performed using the water phase, the oil phase, and the pH adjusting agent aqueous solution that are prepared.

Step 1: a step of reducing a flow diameter of each of the water phase and the oil phase that are flowing, combining the water phase and the oil phase, and continuously causing a two-liquid combined solution to flow

In the step 1, in a case where the extraction device 1 is used, the water phase or the oil phase is transported or caused to flow to the water phase flow pipe 11 and the oil phase flow pipe 12 from a water phase tank or an oil phase tank (not shown) using a transport mechanism, for example, various pumps. In the step 1, a condition for transporting the water phase and the oil phase and a condition for mixing both the phases can be appropriately set. For example, each of the following conditions is preferably set. Regarding each of the conditions, it is preferable that at least one of the water phase or the oil phase satisfies the following preferable range or the like, and it is preferable that both the water phase and the oil phase satisfies the following preferable range or the like from the viewpoints of the amount of metal ions extracted, the durability, and the extraction resolution. Regarding each of the conditions, in a case where both the water phase and the oil phase satisfies the following preferable range or the like, the condition of the water phase and the condition of the oil phase may be the same as or different from each other.

In the step 1, a flow velocity of the water phase cannot be uniquely determined based on the inner pressure, the inner diameter of the water phase flow pipe 11, the ratio between the inner diameters (the inner diameter of the opening end portion of the tapered portion/the given inner diameter of the flow pipe: the inner diameter of the connection portion to the tapered portion), and the like. For example, the flow velocity can be 1.0 to 20.0 mL/min, and is preferably 3.0 to 15.0 mL/min from the viewpoint of improving the mixed state, more preferably 5.0 to 13.0 mL/min from the viewpoint of simultaneously realizing the amount of metal ions extracted, the durability, and the extraction resolution at a high level, and still more preferably 6.0 to 12.0 mL/min. In addition, likewise, an inner pressure of the water phase (flow pressure) cannot be uniquely determined, but can be, for example, 0.01 to 5.0 MPa and is preferably 0.03 to 2.5 MPa from the viewpoint improving the mixed state.

A flow velocity of the oil phase cannot be uniquely determined based on the inner pressure, the inner diameter of the oil phase flow pipe 12, the ratio between the inner diameters, and the like. For example, the flow velocity can be 1.0 to 20.0 mL/min, and is preferably 3.0 to 15.0 mL/min from the viewpoint of improving the mixed state, more preferably 5.0 to 13.0 mL/min from the viewpoint of simultaneously realizing the amount of metal ions extracted, the durability, and the extraction resolution at a high level, and still more preferably 6.0 to 12.0 mL/min. In addition, likewise, an inner pressure of the oil phase (flow pressure) cannot be uniquely determined, but can be, for example, 0.01 to 5.0 MPa and is preferably 0.03 to 2.5 MPa from the viewpoint improving the mixed state.

Flow amounts of the water phase and the oil phase per unit time can be appropriately determined depending on the inner diameter of each of the flow pipes and the like, and further depending on the content of the metal ions, the content of the acidic extractant, and the like. The flow amounts per unit time can also be set to be different or to be the same.

In the extraction method according to the embodiment of the present invention, irrespective of the flow amount per unit time, a ratio (mole) between the content of the metal ions and the content of the acidic extractant during the mixing of the water phase and the oil phase [the content (mole) of the acidic extractant/the total content (mole) of the metal ions in the water phase] is preferably 0.5 to 20.0 times and more preferably 1.0 to 10.0 times. In addition, the content of the acidic extractant to the total content of the metal ions to which the acidic extractant can be coordinated (also referred to as the mixing amount) [the number of moles of the acidic extractant/the total number of moles of the metal ions to which the acidic extractant can be coordinated] can be, for example, 1.0 to 10.0 times and is preferably 1.0 to 7.0 times. Here, the metal ions to which the acidic extractant can be coordinated refer to metal ions that are coordinated to the acidic extractant and are extracted to the oil phase.

As described above, regarding the water phase flowing through the water phase flow pipe 11 and the oil phase flowing through the oil phase flow pipe 12, in a state where each of the flow diameters, that is, the inner diameter of each of the flow pipes is reduced, the water phase and the oil phase outflow to the combining portion 13 and are combined with each other.

In this case, each of the reduction ratios (the above-described ratio between the inner diameters) of the flow diameters of both the phases is not uniquely determined based on the flow velocity, the inner pressure, and the like. For example, the reduction ratio is preferably 0.8 or less with respect to the inner diameter and the flow velocity of each of the flow pipes. From the viewpoint of improving the mixed state, specifically, from the viewpoint of simultaneously realizing the amount of metal ions extracted, the durability, and the extraction resolution at a high level while maintaining rapid phase separability (also referred to as liquid separability) of both the phases after mixing, each of the reduction ratios of the flow diameters of both the phases is more preferably 0.6 or less, and still more preferably 0.55 or less. The lower limit of the reduction ratio is not particularly limited. For example, from the viewpoint of suppressing an excessive inner pressure load, the lower limit can be 0.1 or more and, from the viewpoint of improving the mixed state, is preferably 0.2 or more and more preferably 0.3 or more.

A clearance between the opening end portion of the water phase flow pipe 11 and the opening end portion of the oil phase flow pipe 12 (length of the combining portion 13 (collision region)) is appropriately determined in consideration of the mixed state (collision force) of the water phase and the oil phase and, for example, is 1 to 100 mm.

In the present invention, a flow condition and a combining condition of the water phase and the oil phase can be appropriately selected from the above-described conditions. As the condition of each of the phases during the combining (during the collision of both the phases), kinetic energy EsT per unit area and per unit time (in the present invention, also simply referred to as “kinetic energy”) is preferably set from the viewpoint that the amount of metal ions extracted, the durability, and the extraction resolution can be improved with a good balance. In the present invention, the kinetic energy EsT per unit area and per unit time (J/sec/m²) can be calculated using the following expression (EST) from the density of the fluid (the water phase and the oil phase), a linear velocity and a volume flow rate in the combining portion 13 (the opening end portion of each of the flow pipes), and a cross sectional area.

$${E}_{ST} = ( 1 / 2 ) \times ρ \times {u}^{2} \times Q \times ( 1 / A ) \qquad Expression ( {E}_{ST} )$$

In Expression (EST), p represents the density (kg/m³) of fluid that is flowing, u represents the linear velocity (m/sec) of fluid that is flowing during combining (during flowing into the combining portion 13), Q represents the volume flow rate (m³/sec) of fluid that is flowing during combining (during flowing into the combining portion 13), and A represents the cross sectional area (m²) calculated from the inner diameter in the opening end portion (combining portion 13) of each of the flow pipes.

Here, the density ρ (kg/m³) of the fluid is obtained from (W/100)×1000 (kg/m³) by measuring the mass W (g) of the fluid used in a case where the fluid to be measured is diluted in a 100 mL measuring flask.

The linear velocity u (m/sec) of the fluid can be calculated by multiplying the flow velocity (mL/min) of the fluid by 60×10⁻⁶×1/A (m⁻²). In the present invention, the linear velocity of each of the water phase and the oil phase is not particularly limited and, for example, is preferably 0.01 to 2.0 m/sec and more preferably 0.05 to 1.0 m/sec.

The volume flow rate Q (m³/sec) of the fluid can be converted from the flow velocity (mL/min).

In the present invention, in a case where the kinetic energy Est increases, the mixed state is improved by collision between the water phase and the oil phase, and the phase separability tends to decrease. In this case, the amount of metal ions extracted, the durability, and the extraction resolution (in particular, room-temperature resolution) can be improved. In the present invention, the kinetic energy EsT can be appropriately set in consideration of the flow condition and the combining condition of the water phase and the oil phase. For example, from the viewpoint that an interfacial area between the water phase and the oil phase can be increased to improve the amount of metal ions extracted, the durability, and the extraction resolution, the kinetic energy EsT is preferably 10 J/sec/m² or more, more preferably 50 J/sec/m² or more, still more preferably 200 J/sec/m² or more, and still more preferably 500 J/sec/m² or more. On the other hand, the kinetic energy EsT is preferably 100000 J/sec/m² or less from the viewpoint that the phase separability can be improved, and from the viewpoint that the amount of metal ions extracted, the durability, and the extraction resolution can be further improved while maintaining high phase separability, is more preferably 16000 J/sec/m² or less, still more preferably 10000 J/sec/m² or less, still more preferably 5000 J/sec/m² or less, and most more preferably 100 J/sec/m² or less.

In the present invention, regarding the conditions in a case where the step 1 is performed, each of the above-described conditions can be appropriately selected, and an appropriate combination of the above-described conditions can be set. In the present invention, regarding the conditions in a case where the step 1 is performed, from the viewpoint that the amount of metal ions extracted, the durability, and the extraction resolution can be improved, among the above-described conditions, it is preferable that at least one of the flow velocity, the reduction ratio between the flow diameters (the ratio between the inner diameters), and the kinetic energy EST is set. From the viewpoint that the amount of metal ions extracted, the durability, and the extraction resolution can be improved, it is preferable that the flow velocity and the reduction ratio between the flow diameters are combined and are set to any of the above-described ranges. From the viewpoint that the amount of metal ions extracted, the durability, and the extraction resolution can be simultaneously improved at a higher level, it is still more preferable that the flow velocity, the reduction ratio between the flow diameters, and the kinetic energy Est are combined and are set to any of the above-described ranges. For example, in one preferable aspect, the flow velocity is set to a range of 3.0 to 15.0 mL/min, the reduction ratio between the flow diameters is set to a range of 0.2 to 0.6, and the kinetic energy Est is set to a range of 50 to 100000 J/sec/m². In this aspect, the conditions to be combined can also be in the above-described preferable range. In this aspect, conditions other than the above-described conditions can be combined. For example, it is also preferable that the above-described ratio (mole) [the content (mole) of the acidic extractant/the total content (mole) of the metal ions in the water phase] and/or the content [the number of moles of the acidic extractant/the total number of moles of the metal ions to which the acidic extractant can be coordinated] are combined.

In the present invention, the flow diameter, the inner diameter of the flow pipe, the opening diameter of the tapered portion, and the like are equivalent diameter. “Equivalent diameter” is a term used in the field of mechanical engineering, and is also called an equivalent diameter. Assuming that there is a circular pipe equivalent to a pipe line or a flow path having a given inner cross-sectional shape of the pipe, the diameter of the inner cross-section of the equivalent circular pipe is called equivalent diameter. The equivalent diameter (deq) is defined as deq=4A/p in which A represents an inner cross-sectional area of a pipe line and p represents a wetted perimeter (inner perimeter) of a pipe line. In a case where the above definition is applied to a circular pipe, the equivalent diameter equals the diameter of the inner cross section of the circular pipe. Based on the data regarding an equivalent circular pipe, the equivalent diameter is used for estimating the fluidity or the heat transfer characteristics of the pipe line, and shows the spatial scale (representative length) of a phenomenon. For a square pipe in which a represents one side of the inner cross section of the pipe, the equivalent diameter deq=4a²/4a=a; for an equilateral triangular pipe in which a represents one side thereof, deq=a/3^{1/2}; and for a flow between parallel flat plates in which h represents a height of a flow path, deq=2 h (for example, see “Mechanical Engineering Dictionary”, edited by The Japan Society of Mechanical Engineers, 1997, Maruzen Co., Ltd).

In the step 1, the combining angle of the water phase and the oil phase to be combined is not particularly limited. In the extraction device 1, the combining angle is 180° (facing). In the present invention, the combining angle can be 0° to 180° and, from the viewpoint of improving the mixed state, is preferably 30° to 180°, more preferably 90° to 180°, and still more preferably 150° to 180°

In the step 1, as described above, in the combining portion 13, the water phase that is flowing and the oil phase that is flowing are combined and mixed, preferably, both the phases are combined and mixed by collision, the combined solution is transported to the mixing portion 14, and the mixed solution continuously flows through the inner path of the mixing portion 14.

In a case where the content of the acidic extractant is 35% to 100% by volume, it is not necessary to adjust the content of the oil phase used in the step 1. In a case where the content is less than 35% by volume, the acidic extractant is added to set the content to 35% to 100% by volume.

### <Step 2>

In the extraction method according to the embodiment of the present invention, the following step 2 is performed.

The following step 2 may be performed after or together with the step 1.

Step 2: a step of combining the water phase, the oil phase, and a pH adjusting agent aqueous solution and additionally causing a three-liquid combined solution to flow

In the step 2, in a case where the extraction device 1 is used, the pH adjusting agent aqueous solution is caused to flow into the pH adjusting agent transport pipe 15 from a pH adjusting agent aqueous solution tank (not shown) using a transport mechanism, for example, various pumps, and is transported to the mixing portion 14.

In this case, the flow amount of the pH adjusting agent aqueous solution is set to a value where the pH of the three-liquid combined solution mixed in the mixing portion 14 is a predetermined value. The pH to be set is not uniquely determined and is appropriately determined in consideration of pKa of the acidic extractant, complex formation constants of the acidic extractant and the metal ions, the number of metal ions to be coordinated, and the like. The pH of the three-liquid combined solution (the water phase therein) can be 0.01 to 14. For example, the amount of metal ions extracted, the durability, and the extraction resolution, the pH of the three-liquid combined solution is preferably 0.1 to 10, more preferably 0.5 to 7.0, still more preferably 1.0 to 6.5, still more preferably 2.5 to 6.5, and most preferably 3.0 to 6.5.

In addition, a flow velocity of the pH adjusting agent aqueous solution cannot be uniquely determined based on an inner pressure of the pH adjusting agent transport pipe, an inner diameter of the pH adjusting agent transport pipe 15, an inner pressure of the mixed solution flowing through the mixing portion 14, and the like. For example, the flow velocity of the pH adjusting agent aqueous solution can be 0.05 to 10.0 mL/min. In addition, the inner pressure of the pH adjusting agent aqueous solution (flow pressure) cannot also be uniquely determined and is set to a pressure at which the pH adjusting agent aqueous solution can be transported to the mixing portion 14.

As described above, in the additional flow step 2, the two-liquid combined solution (also referred to as “oil-water combined solution”) of the water phase and the oil phase that are combined in the continuous flow step 1 is combined with the pH adjusting agent aqueous solution, and the combined solution is additionally caused to flow. Specifically, in the extraction method according to the embodiment of the present invention, in a case where the extraction device 1 is used, the pH adjusting agent aqueous solution flowing through the pH adjusting agent transport pipe 15 is transported to the mixing portion 14, the oil phase and the water phase (the two-liquid mixed solution) flowing through the rear-stage mixing portion 14b are combined and mixed with the pH adjusting agent aqueous solution. As a result, the three-liquid combined solution (also referred to as an adjusting agent combined solution) of both the phases and the pH adjusting agent aqueous solution is obtained, and the pH thereof can be adjusted to the predetermined value. Next, the three-liquid combined solution is additionally caused to flow through the rear-stage mixing portion 14b, and is transported to the separation portion 16.

In the extraction method according to the embodiment of the present invention, in a case where the extraction device 2 is used, the step 2 is performed in the step 1. Specifically, in the step 1 using the extraction device 2, the pH adjusting agent aqueous solution directly outflow to the combining portion 23 from the pH adjusting agent transport pipe 15 connected to the combining portion 23, and the three liquids that are flowing through the combining portion 23, that is, the water phase, the oil phase, and the pH adjusting agent aqueous solution are combined. In this case, the flow condition and the like can be set to be the same as the flow condition and the like in the method using the extraction device 1.

This way, by performing the additional flow step 2 in the continuous flow step 1, the water phase, the oil phase, and the pH adjusting agent aqueous solution are combined at a stroke and are additionally caused to flow. Specifically, the water phase flowing through the water phase flow pipe 11, the oil phase flowing through the oil phase flow pipe 12, and the pH adjusting agent aqueous solution flowing through the pH adjusting agent transport pipe 15 are transported to the combining portion 23, and the three liquids (are caused to collide) are mixed in the combining portion 23 to obtain the three-liquid combined solution where the pH is adjusted the predetermined value. Next, the three-liquid combined solution is additionally caused to flow through the mixing portion 24, and is transported to the separation portion 16.

In the present invention, the three-liquid combined solution is phase-separated into a water phase and an oil phase in the step 3 described below. A timing of moment where the extraction equilibrium is reached only needs to be before the phase separation, and may be after transporting the three-liquid combined solution to the separation portion 16 of the extraction device 1 or 2. From the viewpoint that the amount of metal ions extracted, the durability, and the extraction resolution can be further simultaneously improved at a higher level, it is preferable that the extraction of metal ions to be extracted for the three-liquid combined solution reaches the extraction equilibrium during flowing in the step 1 or the step 2 (until the three-liquid combined solution is introduced into the separation portion 16). Specifically, it is preferable that the extraction of metal ions to be extracted reaches the extraction equilibrium while the three-liquid combined solution is flowing through the rear-stage mixing portion 14b of the mixing portion 14 or the mixing portion 24. In the present invention, the water phase and the oil phase are combined with each other in a state where the flow diameters thereof are reduced. Therefore, the mixed state is improved even immediately before a timing of moment of combining, and the metal ions can be extracted. Next, both the phases are mixed during flowing (after pH adjustment). Therefore, it is considered that, while the mixed solution is flowing through the mixing portion 14 or 24, the extraction of the metal ions is promoted such that the extraction equilibrium is rapidly reached.

In the present invention, it can be verified and identified using various methods that the extraction of metal ions to be extracted reaches the extraction equilibrium. For example, the verification and identification can be performed based on, for example, the fact that the pH of the three-liquid combined solution where the pH adjustment by the pH adjusting agent ends (that is flowing through the rear-stage mixing portion 14b or the mixing portion 24) shows a constant value, or the fact that the content (residual amount) of metal ions to be extracted in the water phase that is sampled from the three-liquid combined solution is constant. In the present invention, in order to allow the extraction of metal ions to be extracted to reach the extraction equilibrium while the three-liquid combined solution is flowing through the rear-stage mixing portion 14b or the mixing portion 24, the above-described verification and identification method may be performed on the three-liquid combined solution in advance to determine a flow time (flow path length) of the rear-stage mixing portion 14b or the mixing portion 24 based on the obtained result. A period of time required until the extract of metal ions to be extracted reaches the extraction equilibrium cannot be uniquely determined based on the content of the metal ions in the water phase, the kind of the acidic extractant, the temperature, and the like. For example, the elapsed time from the mixing of the water phase and the oil phase can be set to 1 minute to 24 hours and is preferably 1 to 60 minutes.

It is preferable that, in at least of the step 1 or the step 2, the combined solution is caused to flow through the flow path where the static mixer is provided from the viewpoint of highly improving the mixed state of the combined solution such that the resolution (including the low-temperature resolution) can be further improved. In a case where the extraction device 1 is used, the static mixer can be provided in a flow path of at least one of the front-stage mixing portion 14a and the rear-stage mixing portion 14b in the mixing portion 14, and it is more preferable that the static mixer is provided in the flow path of the rear-stage mixing portion 14b from the viewpoint of further improving the mixed state of the three-liquid combined solution. In a case where the extraction device 2 is used, the static mixer is provided in the flow path of the mixing portion 24.

### <Step 3>

Next, in the extraction method according to the embodiment of the present invention, the following step 3 is performed.

Step 3: a step of separating (phase-separating) the three-liquid combined solution into a water phase and an oil phase after extraction of metal ions to be extracted reaches an extraction equilibrium.

The separation method in the step 3 is not particularly limited, and a well-known separation method, for example, a standing method or a centrifugal separation method can be applied. From the viewpoint that the device configuration is simple and the workability is also excellent, the standing method is preferable. A phase separation condition is not particularly limited as long as it is a condition for separating the three-liquid combined solution into a water phase and an oil phase, and can be appropriately set. A standing time in the standing method can be typically 10 minutes to 24 hours after the three-liquid combined solution is transported to the separation portion 16. In the extraction method according to the embodiment of the present invention, the phase separation after mixing rapidly proceeds. Therefore, the standing time can be set within a short period of time and is preferably, for example, 10 to 60 minutes.

In the extraction method according to the embodiment of the present invention, a temperature at which each of the steps 1 to 3 is performed is not particularly limited and may be a normal temperature or a low temperature. In the extraction method according to the embodiment of the present invention, the low-temperature resolution can be realized. Therefore, the extraction method according to the embodiment of the present invention can also be applied to a low temperature environment. The normal temperature and the low temperature are as described above.

In the extraction method according to the embodiment of the present invention, by performing the steps 1 to 3, the metal ions to which the acidic extractant is coordinate-bonded among the metal ions present in the water phase can be extracted to the oil phase. In addition, the number of kinds of the metal ions extracted to the oil phase is ideally 1 but may also be 2 or more. In this case, for example, the number of kinds of the metal ions can be 2 to 10 and is preferably 2 to 6 and more preferably 2 or 3. The two or more kinds of metal ions extracted to the oil phase among the plural kinds of metal ions are not particularly limited and, for example, are preferably the same as the above-described two or more kinds of different-group metal ions (combination) in the water phase.

### <Multi-Cycle Extraction Method According to Embodiment of Present Invention>

In the extraction method according to the embodiment of the present invention, as described above, deterioration and decomposition of the acidic extractant can be suppressed. As a result, even after the series of multiple extraction separation cycles of the steps 1 to 3 are performed using the used oil phase, a large amount of metal ions extracted, high durability, and high extraction resolution can be maintained. Therefore, the series of multiple extraction separation cycles of the steps 1 to 3 can be performed while reusing the oil phase.

In the extraction method according to the embodiment of the present invention (also referred to as the multi-cycle extraction method according to the embodiment of the present invention) in which the series of multiple extraction separation cycles is performed, the extraction separation cycle including the steps 1 to 3 can be performed as long as the amount of metal ions extracted using the acidic extractant in the oil phase, the durability, and the extraction resolution can be maintained. For example, 2 to 100 cycles, preferably, 5 to 50 cycles can be performed. In the multi-cycle extraction method according to the embodiment of the present invention, the oil phase that is phase-separated in the phase separation step 3 can be reused as the oil phase of the next extraction separation cycle, optionally after stripping metal ions and adjusting the content of the acidic extractant. In the multi-cycle extraction method according to the embodiment of the present invention, extraction costs can be further reduced. The oil phase (used oil phase) obtained in the step 3 is normally used after stripping metal ions, but can also be used without stripping metal ions in consideration of the content of metal ions in the water phase, the amount of metal ions extracted, and the like. As a method of stripping (isolating) the metal ions from the oil phase, a well-known method can be applied without any particular limitation. For example, the different-group metal ions can be stripped by adjusting the liquid phase to be acidic, for example, pH of 4 or less using an inorganic acid such as sulfuric acid, hydrochloric acid, or nitric acid. The stripping method may be a batch type but is preferably a flow type from the viewpoint that the advantages of the extraction method according to the embodiment of the present invention do not deteriorate. A stripping device using the flow type stripping method is not particularly limited. However, the extraction device suitable for the embodiment of the present invention can also be used from the viewpoints of workability, cost reduction, and the like.

A multi-cycle extraction device that is suitably used for the multi-cycle extraction method according to the embodiment of the present invention is not particularly limited. For example, in the extraction device 1 or 2, the oil phase discharge pipe 16a connected to the separation portion 16 is connected to an oil phase tank (not shown in FIGS. 1 and 2) or to the oil phase tank in the oil phase flow pipe 12 and an intermediate portion of the combining portion through a device for stripping metal ions in the oil phase.

### <Other Steps>

The extraction method according to the embodiment of the present invention may include steps other than the above-described steps 1 to 3. Examples of the other steps include a step of stripping (isolating) metal ions from the oil phase that is phase-separated in the step 3 (step of stripping metal ions from the oil phase to recycle the oil phase), a step of recovering the stripped metal ions as a compound (salt), a step of purifying the stripped metal ions or the compound thereof, a step of purifying the acidic extractant recovered from the oil phase, and a step of removing ions of metal elements belonging to Group 1 or Group 2 in the periodic table of elements from the water phase in advance. As a method of recovering the stripped metal ions as a compound, a well-known method can be applied without any particular limitation.

By using the above-described flow type mixing method, although the extraction method according to the embodiment of the present invention is a simple method, the amount of metal ions extracted in one extraction separation cycle is large, a high extraction rate can be maintained even after multiple extraction separation cycles are performed, and while maintaining high extraction resolution even in a low temperature condition, metal ions in the water phase can be extracted to the oil phase. In particular, in a case where the water phase includes plural kinds of metal ions, the amount of metal ions extracted in one extraction separation cycle is large, a high extraction rate can be maintained even after multiple extraction separation cycles are performed, and while maintaining high extraction resolution even in a low temperature condition, specific metal ions among the plural kinds of metal ions can be extracted to the oil phase. Accordingly, the extraction method according to the embodiment of the present invention can also be referred to as a method of separating and recovering specific metal ions from the metal ions present in the water phase.

One specific kind of metal ions that can be extracted or separated and recovered is not uniquely determined based on the group or the period of the metal ions, the content thereof, the kind of the acidic extractant, and the like. For example, in a case where metal ions belonging to Group 9 and metal ions belonging to Group 10 are extracted to the oil phase, the metal ions belonging to Group 9 can be separated and recovered in a large amount with a high extraction rate and high extraction resolution (including the low-temperature resolution). In particular, in a case where Co ions as metal ions belonging to Group 9 and Ni ions as metal ions belonging to Group 10 are extracted, the Co ions can be separated and recovered in a large amount with a high extraction rate and high extraction resolution. In addition, in a case where metal ions belonging to Group 7 and metal ions belonging to Group 9 are extracted to the oil phase, the metal ions belonging to Group 7 can be separated and recovered in a large amount with a high extraction rate and high extraction resolution (including the low-temperature resolution). In particular, in a case where Mn ions as metal ions belonging to Group 7 and Co ions as metal ions belonging to Group 9 are extracted, the Mn ions can be separated and recovered in a large amount with a high extraction rate and high extraction resolution. Further, in a case where metal ions belonging to Group 9 and metal ions belonging to Group 11 are extracted to the oil phase, the metal ions belonging to Group 11 can be separated and recovered in a large amount with a high extraction rate and high extraction resolution. Further, in a case where metal ions belonging to Group 9, metal ions belonging to Group 10, and metal ions belonging to Group 12 are extracted to the oil phase, the metal ions belonging to Group 10 are not typically extracted, and the metal ions belonging to Group 12 can be separated and recovered in a large amount with a high extraction rate and high extraction resolution.

In the extraction method according to the embodiment of the present invention, as described above, specific metal ions among the metal ions present in the water phase can be extracted and recovered to the oil phase in a large amount with a high extraction rate and high extraction resolution. In particular, in the extraction method according to the embodiment of the present invention, while extracting two or more kinds of metal ions present in the water phase, one kind of metal ions among the metal ions can be separated and recovered in a large amount with a high extraction rate and high extraction resolution. Therefore, by further subjecting the water phase including the two or more kinds of metal ions stripped from the oil phase to the extraction method according to the embodiment of the present invention, the selectivity of one kind of metal ions can be further improved without significant deterioration in the amount of metal ions recovered (recovery rate) irrespective of the operating temperature, and thus high-purity metal ions can be recovered in a large amount (recovery rate).

### <Acidic Extractant>

The acidic extractant used for the extraction method according to the embodiment of the present invention only needs to be a metal extractant consisting of an acidic compound having at least one active hydrogen atom, and examples thereof include various well-known acidic extractants or a phosphoric acid-based compound represented by Formula (I) below.

Examples of the active hydrogen atom in the compound include active hydrogen atoms in a hydroxy group (including a phenolic hydroxy group and a hydroxy group bonded to a phosphorus atom or a sulfur atom), a carboxy group, and a sulfanyl group.

The acidic extractant is acidic, and the pKa thereof is not particularly limited. As the pKa, an appropriate value can be adopted, and a value of 0.1 to 12 is preferable. The pKa can be measured using a neutralization titration method.

Examples of various well-known acidic extractants include a phosphoric acid-based compound, a carboxylic acid-based compound, a sulfonic acid-based compound, an oxime-based compound, a β-diketone compound, and an oxine-based compound. Examples of the phosphoric acid-based compound include a phosphoric acid compound, a phosphonic acid compound, a phosphinic acid compound, and a compound obtained by substituting an oxygen atom in the above-described compound with a sulfur atom. For example, various compounds described in paragraph 0046 of JP2016-019939A can be used. As the carboxylic acid-based compound, for example, a compound VA-10 used in Examples below can be used.

From the viewpoint that the amount of metal ions extracted, the durability, and the extraction resolution can be simultaneously improved at a high level, the acidic extractant used in the extraction method according to the embodiment of the present invention is preferably a compound represented by Formula (I) below.

Examples of the compound represented by Formula (I) include a compound including an acid group where at least one oxygen atom is substituted with a sulfur atom or a nitrogen atom of a phosphate group, a phosphonate group, a phosphinate group, and an acid group thereof. Examples of the compound having the acid group include a phosphoric acid-based compound such as a phosphate compound (R¹O—P(═O)(O)—OR²), a phosphonate compound (R¹—P(═O)(O)—OR², R¹O—P(═O)(O)—R²), or a phosphinic acid compound (R¹—P(═O)(O)—R²), a thiophosphoric acid-based compound where at least one oxygen atom in each of the phosphoric acid-based compounds is converted into a sulfur atom, and a compound where an oxygen atom (—O) bonded to P is substituted with a nitrogen atom. From the viewpoint that the amount of metal ions extracted, the durability, and the extraction resolution can be further simultaneously improved at a higher level, the acidic extractant represented by Formula (I) is preferably a phosphoric acid-based compound, more preferably a phosphate compound, a phosphonate compound, or a phosphinate compound, still more preferably a phosphonate compound, and still more preferably a phosphonic acid monoester compound.

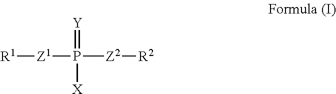

In Formula (I), R¹ and R² each independently represent a substituent. Here, a substituent of at least one of R¹ or R² is a hydrocarbon group having 9 or more carbon atoms.

The substituents that can be used as R¹ and R² are not particularly limited, and examples thereof include various substituents and a group including a combination of substituents. In the present invention, “various substituents” described above each independently refer to the substituents represented by R¹ and R², and “the group including a combination of substituents” refer to a substituent including a combination of a plurality of substituents. In order to clearly distinguish between “various substituents” and “the group including a combination of substituents”, each of “various substituents” will also be referred to as “single substituent”, and “the group including a combination of substituents” will also be referred to as “complex substituent”. The complex substituent is formed by typically removing hydrogen atoms of a necessary number of single substituents from single substituents forming the complex substituent to bond a plurality of single substituents to each other.

In the complex substituent, a position where a specific substituent is substituted with another substituent is not particularly limited, and can be appropriately determined. For example, in a case where a phenyl group is substituted with another substituent, the substitution position may be any one of the 2-, . . . , or 4-position with respect to the bonding position of the phenyl group.

In the present invention, the substituents that can be used as the R¹ and R² can be interpreted as single substituents as much as possible. For example, a 2-ethylhexyl group can also be interpreted as a complex substituent where an ethyl group is substituted with a hexyl group, but is interpreted as a branched alkyl group. In addition, a hexyloxy group can also be interpreted as a complex substituent including a combination of a hexyl group and an oxygen atom, but can be interpreted as an alkoxy group.

Each of the substituents that can be used as R¹ and R² (including a single substituent and a complex substituent) may also be a hydrocarbon group including only a carbon atom and a hydrogen atom, or may also be a heteroatom-containing substituent including at least one kind of a heteroatom such as a nitrogen atom, an oxygen atom, or a sulfur atom. From the viewpoint that the amount of metal ions extracted, the durability, and the extraction resolution can be simultaneously improved at a higher level with a good balance, it is preferable that the substituents that can be used as R¹ and R² are hydrocarbon groups.

The heteroatom-containing substituent preferably includes an oxygen atom or a sulfur atom and more preferably includes an oxygen atom as a heteroatom. In addition, the number of heteroatoms in the heteroatom-containing substituent is not particularly limited, and can be 1 to 4 and is preferably 1. In the heteroatom-containing substituent, the heteroatom may be present at any position of the substituent, for example, may be present at an atomic chain forming the substituent or at a terminal thereof. The heteroatom-containing substituent is not particularly limited, and examples thereof include a single substituent such as an alkoxy group, an aryloxy group, a heterocyclic oxy group, an alkylthio group, an arylthio group, or a heterocyclic thio group described below, and a complex substituent such as a group including a combination of the single substituent and an aryl group (a substituent having a ring structure).

The single substituents that can be used as R¹ and R² are not particularly limited. For example, an appropriate substituent can be used, and examples thereof include groups selected from the substituent G described below. Among these, a hydrocarbon group such as an alkyl group, an alkenyl group, an alkynyl group, or an aryl group, a heterocyclic group, or the like is preferable, and an alkyl group is more preferable from the viewpoint that the amount of metal ions extracted, the durability, and the extraction resolution can be simultaneously improved at a higher level with a good balance.

Any of the alkyl group, the alkenyl group, or the alkynyl group that can be used as the single substituent may be a straight chain, a branched chain, or a cyclic chain and is more preferably a branched chain from the viewpoint that the amount of metal ions extracted, the durability, and the extraction resolution can be simultaneously improved at a higher level with a good balance.

An aryl group or a heterocyclic group that can be used as the single substituent is the same as each corresponding group in the substituent G described below.

The complex substituents that can be used as R¹ and R² are not particularly limited, and examples thereof include a group including a combination of a plurality of (single) substituents, for example, substituents selected from the substituent G. The number of single substituents forming the complex substituent is not particularly limited, and can be 2 to 6 and is preferably 2 to 4.

Examples of the complex substituent include a group including a combination of hydrocarbon groups (a group including an alkyl group, an alkenyl group, or an alkynyl group and an aryl group), a group (hydroxyaryl group) including a combination of a hydroxyl group and an aryl group, a group including a combination of an alkoxy group or an alkylthio group and an aryl group, and a group including a combination of an alkyl group, an alkenyl group, or an alkynyl group and an amino group. In a case where the complex substituent includes an oxygen atom or a sulfur atom bonded to the alkyl group, the oxygen atom or the sulfur atom is interpreted as each of the atoms derived from the alkoxy group or the alkylthio group. For example, “alkyl group-oxygen atom-phenyl group” as a complex substituent is interpreted as a group including a combination of an alkoxy group and a phenyl group without being interpreted as a group including a combination of an alkyl group and a phenoxy group and as a group including a combination of an alkyl group, an oxygen atom, and a phenyl group. The above-described interpretation also applies to a case where the complex substituent includes an oxygen atom bonded to an alkenyl group or an alkynyl group.

It is preferable that the complex substituent include a ring structure from the viewpoints of the amount of metal ions extracted, the durability, and the extraction resolution. The ring structure in the complex substituent is not particularly limited, and examples thereof include a ring structure derived from a cycloalkyl group, an aryl group, or a heterocyclic group. A ring structure derived from an aryl group or an aromatic heterocyclic group is preferable, and from the viewpoints of the amount of metal ions extracted, the durability, and the extraction resolution, a ring structure derived from an aryl group is more preferable. As the complex substituent including the ring structure, specifically, a group including a combination of an alkyl group and an aryl group, a group including a combination of an alkoxy group or an alkylthio group and an aryl group, or the like is preferable, an alkoxyaryl group is more preferable, and an alkoxyphenyl group is still more preferable.

From the viewpoints of the amount of metal ions extracted, the durability, and the extraction resolution, as each of the substituents that can be used as R¹ and R², an alkyl group, or a complex substituent including a combination of an alkoxy group or an alkylthio group and an aryl group and including a ring structure is preferable among the above-described examples.

Among the preferable substituents, it is preferable that a complex substituent including an alkoxy group, an alkylthio group, and a ring structure has 9 or more carbon atoms.

A combination of the substituent that can be used as R¹ and the substituent that can be used as R² is not particularly limited, and the substituents that can be used as R¹ and R² can be appropriately combined.

For example, a molecular structure of the substituent is not particularly limited. From the viewpoint that the amount of metal ions extracted, the durability, and the extraction resolution can be further simultaneously improved at a higher level, as the substituents that can be used as R¹ and R², a combination including a substituent having a branched structure (a combination of substituents at least one of which has a branched structure) is preferable, and a combination of substituents having a branched structure or a combination of a substituent having a branched structure and a substituent including a ring structure (in particular, a complex substituent) is more preferable. Here, the substituent having a branched structure is not particularly limited. Among the above-described examples, for example, a hydrocarbon group such as an alkyl group, an alkenyl group, or an alkynyl group, or a single substituent or a complex substituent including a hydrocarbon group can be used. A single substituent such as an alkyl group, or a complex substituent such as a group including a combination of an alkoxy group or an alkylthio group and an aryl group is preferable, and an alkyl group or a group including a combination of an alkoxy group and an aryl group is more preferable.

In the present invention, it is preferable that the substituent having a branched structure is a substituent having 9 or more carbon atoms from the viewpoint that the amount of metal ions extracted, the durability, and the extraction resolution can be further simultaneously improved at a higher level.

In addition, the kind of the substituent is not particularly limited. As the combination of the substituents that can be used as R¹ and R², from the viewpoints of the amount of metal ions extracted, the durability, and the extraction resolution, a combination of single substituents or a combination of a single substituent and a complex substituent is preferable.

In the combination of single substituents, a combination of the same (kind of) substituents may be used, or a combination of different (kinds of) substituents may be used. Examples of the combination of the same substituents include a combination of alkyl groups, a combination of alkenyl groups, and a combination of alkynyl groups. In the combination of the same substituents, carbon chains of single substituents to be combined may be the same as or different from each other, and are preferably branched chains. In addition, the numbers of carbon atoms in the single substituents to be combined may be the same as or different from each other.

On the other hand, examples of a combination of different substituents include combinations where one substituent is a hydrocarbon group. Among these, a combination of two of an alkyl group, an alkenyl group, and an alkynyl group is preferable. In the combination of different substituents, a carbon chain of an alkyl group, an alkenyl group, or an alkynyl group may be the same as or different from one other, but both the carbon chains are preferably branched chains. In addition, the number of carbon atoms in an alkyl group, an alkenyl group, or an alkynyl group may be the same as or different from one another.

As the combination of the single substituent and the complex substituent, a combination of an alkyl group, an alkenyl group, an alkynyl group, and a complex substituent including a ring structure is preferable, and a combination of an alkyl group and a complex substituent including a combination of an alkoxy group and an aryl group is more preferable.

As the combination of the substituent that can be used as R¹ and the substituent that can be used as R², a combination of alkyl groups is more preferable among the above-described combinations from the viewpoint that the amount of metal ions extracted, the durability, and the extraction resolution can be further simultaneously improved at a higher level.

In the compound represented by Formula (I), each of the substituents that can be used as R¹ and R² can be appropriately selected from the above-described substituents. A substituent of at least one of R¹ or R² is a hydrocarbon group having 9 or more carbon atoms. In a case where a substituent of at least one of R¹ or R² is a hydrocarbon group having 9 or more carbon atoms, the amount of metal ions extracted, the durability, and the extraction resolution can be further simultaneously improved at a higher level. In the present invention, from the viewpoint that, in particular, the low-temperature resolution can be highly improved while maintaining a large amount of metal ions extracted, high durability, and high extraction resolution at a normal temperature, in a case where at least one of R¹ or R² represents a hydrocarbon group having 9 or more carbon atoms, it is preferable that one of Z¹ or Z² represents a single bond, and the other one represents —O—.

From the viewpoint that the amount of metal ions extracted, the durability, and the extraction resolution can be simultaneously improved at a higher level with a good balance, the total number of carbon atoms (hereinafter, simply referred to as the number of carbon atoms) forming the hydrocarbon group having 9 or more carbon atoms is preferably 10 or more, more preferably 12 or more, still more preferably 14 or more, and still more preferably 16 or more. On the other hand, the upper limit of the number of carbon atoms is not particularly limited, and can be appropriately determined. For example, the upper limit can be 30 or less and is preferably 24 or less and more preferably 20 or less.

The hydrocarbon group having 9 or more carbon atoms is not particularly limited. Among the above-described hydrocarbon groups, an alkyl group, an alkenyl group, an alkynyl group is preferable, and an alkyl group is more preferable.

The hydrocarbon group having 9 or more carbon atoms may be a straight chain or a branched chain and is preferably a branched chain. In a case where the hydrocarbon group having 9 or more carbon atoms is a branched chain, the number of branched carbon atoms is not particularly limited as long as it is 1 or more, and examples thereof include an aspect where the number of branched carbon atoms is 1 or 2 and an aspect where the number of branched carbon atoms is 3 or more. In the aspect where the number of branched carbon atoms is 3 or more, the number of branched carbon atoms is the same as that of the hydrocarbon group having 3 or more branched carbon atoms described below.

As the hydrocarbon group having 9 or more carbon atoms, an alkyl group having 9 or more carbon atoms is preferable, and a branched alkyl group having 1 or more branched carbon atoms and having 9 or more carbon atoms is more preferable. Examples of the linear alkyl group having 9 or more carbon atoms include an n-nonyl group, an n-decyl group, an n-dodecyl group, an n-tetradecyl group, and an n-hexadecyl group. Examples of the alkyl group having 9 or more carbon atoms and having one or two branched carbon atoms include 1-ethyl-1-methylhexane, 8-methylnonane, 2-butyloctane, 2-hexyldecane, 2-ethyldecane, 2-octyldecane, 2-hexyldodecane, 2-octyldodecane, and 2-decyltetradecane. Examples of the alkyl group having 9 or more carbon atoms and having 3 or more branched carbon atoms include 2,5,7,7-tetramethyloctane, 2-(1,3,3-trimethyl-1-butyl)-5,7,7-trimethyl-octane, and 2-(4-methylhexyl)-8-methyl-decyl.

In the compound represented by Formula (I), each of the substituents that can be used as R¹ and R² can be appropriately selected from the above-described substituents. Focusing on the molecular structure and the number of carbon atoms in the substituent, it is preferable that at least of R¹ or R² represents a hydrocarbon group having 3 or more branched carbon atoms from the viewpoints of the amount of metal ions extracted, the durability, and the extraction resolution.

The hydrocarbon group having 3 or more branched carbon atoms is not particularly limited, and examples thereof include an alkyl group, an alkenyl group, or an alkynyl group having a branched structure that has 3 or more branched carbon atoms (tertiary carbon atoms). The number of branched carbon atoms present in the hydrocarbon group is not particularly limited as long as it is 3 or more. For example, the number of branched carbon atoms can be 3 to 8 and is preferably 3 to 6 and more preferably 4 to 6. The number of carbon atoms in the hydrocarbon group having 3 or more branched carbon atoms is not particularly limited, and is preferably 9 or more and more preferably 12 or more. That is, it is preferable that the hydrocarbon group having 9 or more carbon atoms includes three or more branched carbon atoms. The hydrocarbon group is as described above.

The other one of R¹ or R² may be a hydrocarbon group having 9 or more carbon atoms or may be a substituent other than the hydrocarbon group having 9 or more carbon atoms. In the present invention, from the viewpoint that the amount of metal ions extracted, the durability, and the extraction resolution can be further simultaneously improved at a higher level, the substituent that can be used as the other one of R¹ or R² is preferably a hydrocarbon group and more preferably a hydrocarbon group having 8 or less carbon atoms.

Examples of the hydrocarbon group having 8 or less carbon atoms include an alkyl group, an alkenyl group, an alkynyl group, and an aryl group. Among these, an alkyl group is preferable. The hydrocarbon group may be a straight chain, a branched chain, or a cyclic chain and is more preferably a branched chain from the viewpoint that the amount of metal ions extracted, the durability, and the extraction resolution can be further simultaneously improved at a higher level. The number of branched carbon atoms present in the branched chain may be 1 or more and, for example, is preferably 1 to 5 and more preferably 1. The total number of carbon atoms forming the hydrocarbon group having 8 or less carbon atoms is preferably 1 to 8, more preferably 3 to 8, and still more preferably 5 to 8.

In the present configuration, the combination of the substituent that can be used as R¹ and the substituent that can be used as R² is not particularly limited, and any one of the substituents may be a hydrocarbon group having 9 or more carbon atoms and is preferably a substituent that includes a hydrocarbon group having 9 or more carbon atoms and one or more branched carbon atoms and more preferably a substituent that includes a hydrocarbon group having 3 or more branched carbon atoms.

In Formula (I), X represents-OH or —SH and preferably —OH.

In Formula (I), Y represents an oxygen atom or a sulfur atom and preferably an oxygen atom.

In Formula (I), Z¹ and Z² each independently represent a single bond, —O—, —NH—, or —S— and preferably a single bond or —O—. In Formula (I), it is preferable that any of Z¹ or Z² represents a single bond or —O—, and among the combinations of Z¹ and Z², it is more preferable that one of Z¹ or Z² represents a single bond, and the other one represents —O—, from the viewpoints of the amount of metal ions extracted, the durability, and the extraction resolution.

The compound represented by Formula (I) can be formed by appropriately combining R¹ and R², Y, and Z¹ and Z², and is preferably formed by combining preferable examples of the respective numerals.

In Formula (I), even in a case where R¹—Z¹— and R²—Z²-represents substituent —O—, substituent —S—, or substituent —NH— and this group may be interpreted as one substituent (for example, an alkoxy group), this group is not interpreted as one substituent, and —O—, —S—, or —NH— is interpreted as Z¹ or Z² and the substituent is interpreted as R¹ or R².

The molecular weight of the compound represented by Formula (I) is not particularly limited, and can be, for example, 350 to 50000. In a case where the oil phase includes an organic solvent, the molecular weight is preferably 400 to 10000 from the viewpoint of, for example, solubility in the organic solvent.

The compound represented by Formula (I) may include a substituent, and examples of the substituent that may be included in the compound include groups selected from the substituent G described below.

The compound represented by Formula (I) can be synthesized with reference to a well-known synthesis method, for example, a synthesis method described in Examples described below.

Specific examples of the compound represented by Formula (I) include the following compounds in addition to compounds synthesized in Examples, but the present invention is not limited thereto.

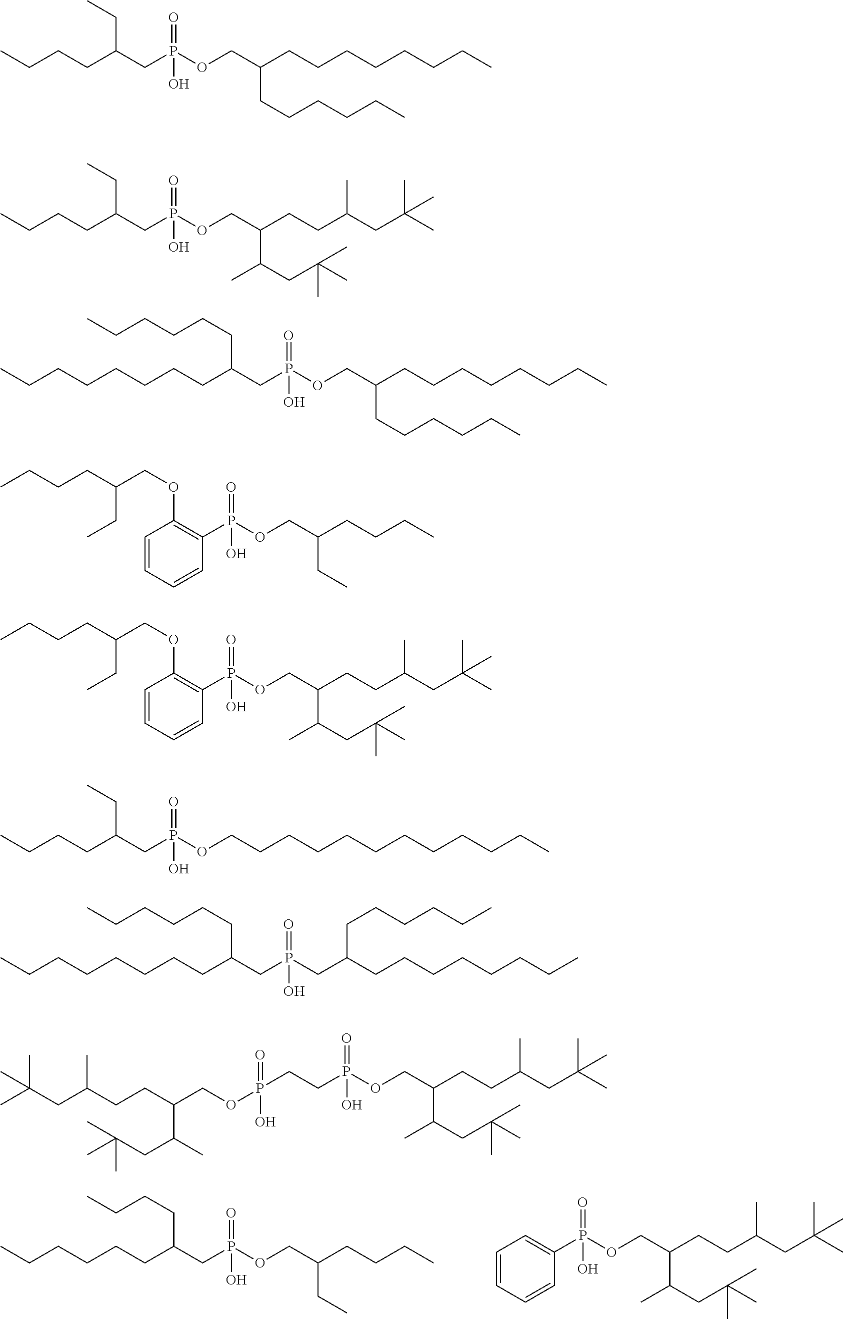

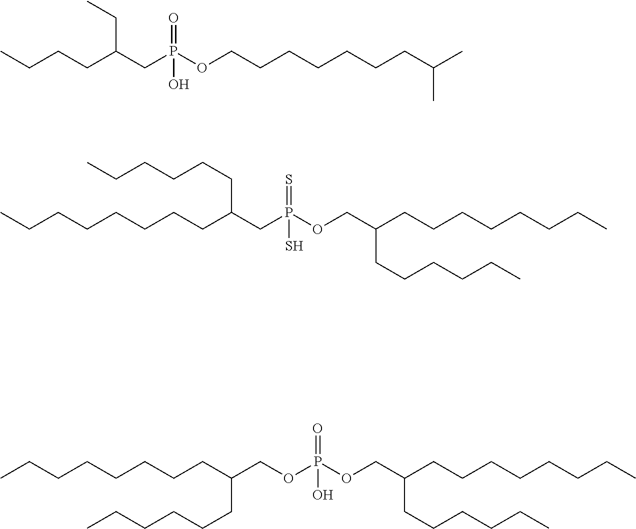

The substituent G includes an alkyl group (preferably an alkyl group having 1 to 20 carbon atoms, for example, methyl, ethyl, isopropyl, t-butyl, pentyl, heptyl, 1-ethylheptyl, benzyl, 2-ethoxyethyl, or 1-carboxymethyl), an alkenyl group (preferably an alkenyl group having 2 to 20 carbon atoms, for example, vinyl, allyl, or oleyl), an alkynyl group (preferably an alkynyl group having 2 to 20 carbon atoms, for example, ethynyl, butadiynyl, or phenyl-ethynyl), a cycloalkyl group (preferably a cycloalkyl group having 3 to 20 carbon atoms, for example, cyclopropyl, cyclopentyl, cyclohexyl, or 4-methylcyclohexyl; although the meaning of the alkyl group described in the present invention typically include a cycloalkyl group, the alkyl group and the cycloalkyl group are separately described here), an aryl group (preferably an aryl group having 6 to 26 carbon atoms, for example, phenyl, 1-naphthyl, 4-methoxyphenyl, 2-chlorophenyl, or 3-methylphenyl), an aralkyl group (preferably an aralkyl group having 7 to 23 carbon atoms, for example, benzyl or phenethyl), a heterocyclic group (preferably a heterocyclic group having 2 to 20 carbon atoms and more preferably a 5- or 6-membered heterocyclic group having at least one oxygen atom, one sulfur atom, or one nitrogen atom; the heterocyclic group includes an aromatic heterocyclic group and an aliphatic heterocyclic group; for example, a tetrahydropyran ring group, a tetrahydrofuran ring group, a 2-pyridyl group, a 4-pyridyl group, a 2-imidazolyl group, a 2-benzimidazolyl group, a 2-thiazolyl group, a 2-oxazolyl group, or a pyrrolidone group), an alkoxy group (preferably an alkoxy group having 1 to 20 carbon atoms, for example, methoxy, ethoxy, isopropyloxy, or benzyloxy), an aryloxy group (preferably an aryloxy group having 6 to 26 carbon atoms, for example, phenoxy, 1-naphthyloxy, 3-methylphenoxy, or 4-methoxyphenoxy), a heterocyclic oxy group (a group in which an —O— group is bonded to the above-described heterocyclic group), an alkoxycarbonyl group (preferably an alkoxycarbonyl group having 2 to 20 carbon atoms, for example, ethoxycarbonyl, 2-ethylhexyloxycarbonyl, or dodecyloxycarbonyl), an aryloxycarbonyl group (preferably an aryloxycarbonyl group having 7 to 26 carbon atoms, for example, phenoxycarbonyl, 1-naphthyloxycarbonyl, 3-methylphenoxycarbonyl, or 4-methoxyphenoxycarbonyl), a heterocyclic oxycarbonyl group (a group in which an —O—CO— group is bonded to the above-described heterocyclic group), an amino group (preferably an amino group having 0 to 20 carbon atoms, an alkylamino group, or an arylamino group, for example, amino (—NH₂), N,N-dimethylamino, N,N-diethylamino, N-ethylamino, or anilino), a sulfamoyl group (preferably a sulfamoyl group having 0 to 20 carbon atoms, for example, N,N-dimethylsulfamoyl or N-phenylsufamoyl), an acyl group (including an alkylcarbonyl group, an alkenylcarbonyl group, an alkynylcarbonyl group, an arylcarbonyl group, and a heterocyclic carbonyl group; preferably an acyl group having 1 to 20 carbon atoms, for example, acetyl, propionyl, butyryl, octanoyl, hexadecanoyl, acryloyl, methacryloyl, crotonoyl, benzoyl, a naphthoyl, or nicotinoyl), an acyloxy group (including an alkylcarbonyloxy group, an alkenylcarbonyloxy group, an alkynylcarbonyloxy group, and a heterocyclic carbonyloxy group; preferably an acyloxy group having 1 to 20 carbon atoms, for example, acetyloxy, propionyloxy, butyryloxy, octanoyloxy, hexadecanoyloxy, acryloyloxy, methacryloyloxy, crotonoyloxy, or nicotinoyloxy), an aryloyloxy group (preferably an aryloyloxy group having 7 to 23 carbon atoms, for example, benzoyloxy or naphthoyloxy), a carbamoyl group (preferably a carbamoyl group having 1 to 20 carbon atoms, for example, N,N-dimethylcarbamoyl or N-phenylcarbamoyl), an acylamino group (preferably an acylamino group having 1 to 20 carbon atoms, for example, acetylamino or benzoylamino), an alkylthio group (preferably an alkylthio group having 1 to 20 carbon atoms, for example, methylthio, ethylthio, isopropylthio, or benzylthio), an arylthio group (preferably an arylthio group having 6 to 26 carbon atoms, for example, phenylthio, 1-naphthylthio, 3-methylphenylthio, or 4-methoxyphenylthio), a heterocyclic thio group (a group in which an —S—group is bonded to the above-described heterocyclic group), an alkylsulfonyl group (preferably an alkylsulfonyl group having 1 to 20 carbon atoms, for example, methylsulfonyl or ethylsulfonyl), an arylsulfonyl group (preferably an arylsulfonyl group having 6 to 22 carbon atoms, for example, benzenesulfonyl), an alkylsilyl group (preferably an alkylsilyl group having 1 to 20 carbon atoms, for example, monomethylsilyl, dimethylsilyl, trimethylsilyl, or triethylsilyl), an arylsilyl group (preferably an arylsilyl group having 6 to 42 carbon atoms, for example, triphenylsilyl), an alkoxysilyl group (preferably an alkoxysilyl group having 1 to 20 carbon atoms, for example, monomethoxysilyl, dimethoxysilyl, trimethoxysilyl, or triethoxysilyl), an aryloxysilyl group (preferably an aryloxysilyl group having 6 to 42 carbon atoms, for example, triphenyloxysilyl), a phosphoryl group (preferably a phosphate group having 0 to 20 carbon atoms, for example, —OP(═O)(R^{P})₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(R^{P})₂), a phosphonate group (preferably a phosphonate group having 0 to 20 carbon atoms, for example, —PO(OR^{P})₂), a sulfo group (a sulfonate group), a carboxy group, a hydroxy group, a sulfanyl group, a cyano group, and a halogen atom (for example, a fluorine atom, a chlorine atom, a bromine atom, or an iodine atom). R^{P} represents a hydrogen atom or a substituent (preferably a group selected from the substituent G).

In addition, each group exemplified in the substituent G may be further substituted with the substituent G.

The alkyl group, the alkylene group, the alkenyl group, the alkenylene group, the alkynyl group, the alkynylene group, and/or the like may be cyclic or chained, may be linear or branched.

### EXAMPLES

Hereinafter, the present invention will be described in more detail based on Examples but is not limited to these examples.

“Parts” and “%” that represent compositions in the following Examples are mass-based unless otherwise specified. In the present invention, “room temperature” refers to 25° C.

### Synthesis and Preparation of Compounds

Compounds shown below were synthesized and prepared.

Regarding PC-88A (mono-2-ethylhexyl(2-ethylhexyl)phosphonate) shown below, a commercially available product (manufactured by Tokyo Chemical Industry Co., Ltd.) was used. In addition, regarding VA-10 shown below, a commercially available product (Versatic acid 10, manufactured by Hexion Specialty Chemicals, Inc.) was used.

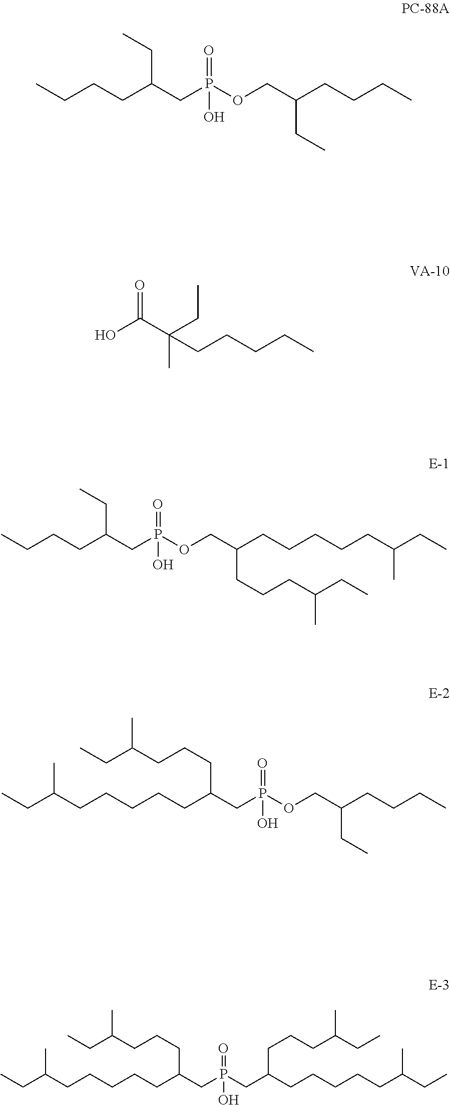

### Synthesis of Compound E-1

A compound E-1 was synthesized as follows.

That is, 89 g of diethyl phosphite (manufactured by Tokyo Chemical Industry Co., Ltd.) and 450 g of tetrahydrofuran (manufactured by FUJIFILM Wako Pure Chemical Corporation) were added to a 1 L three-necked eggplant flask, and were stirred well. While cooling the three-necked eggplant flask with ice, 23.2 g of sodium hydride (manufactured by FUJIFILM Wako Pure Chemical Corporation) was further added, and the reaction solution was stirred under ice cooling for 20 minutes. Next, the reaction solution was heated and was stirred in a reflux state for 30 minutes. Next, while cooling the three-necked eggplant flask with ice, 70.0 g of 1-bromo-2-ethylhexane (manufactured by Tokyo Chemical Industry Co., Ltd.) was added dropwise to the obtained reaction solution over 20 minutes, and the reaction solution was stirred at an internal temperature of 45° C. for 24 hours. After adding 300 g of water to the reaction solution obtained thus far, the reaction solution was extracted with toluene, and the solvent was distilled off under reduced pressure. As a result, 105 g of yellow liquid was obtained.

Next, the obtained yellow liquid and 400 g of dichloromethane (manufactured by FUJIFILM Wako Pure Chemical Corporation) were added to a 1 L three-necked eggplant flask, and were stirred well. 113 g of bromotrimethylsilane (manufactured by Tokyo Chemical Industry Co., Ltd.) was further added to the three-necked eggplant flask, and the reaction solution was stirred at room temperature for 4 hours. After distilling off the solvent from the obtained reaction solution under reduced pressure, 530 g of methanol (manufactured by FUJIFILM Wako Pure Chemical Corporation) was added, and the reaction solution was stirred at an internal temperature of 40° C. for 3 hours. After adding 200 mL of a sodium hydroxide aqueous solution (4 mol/L) to the reaction solution obtained thus far, the water phase was cleaned with toluene twice. After adding 65 mL of concentrated hydrochloric acid to the obtained aqueous solution, the reaction solution was extracted with toluene, and the solvent was distilled off under reduced pressure. As a result, 41.2 g of a compound A (yield: 59%, two steps) was obtained.

20.0 g of the compound A, 23.6 g of FINEOXOCOL 180N (branched C₁₈H₃₇OH, manufactured by Nissan Chemical Corporation), and 120 g of tetrahydrofuran (manufactured by FUJIFILM Wako Pure Chemical Corporation) were added to a 500 mL three-neck flask, and the reaction solution was stirred and heated in a reflux state. A solution where 23.4 g of dicyclohexylcarbodiimide (manufactured by FUJIFILM Wako Pure Chemical Corporation) was dissolved in 120 g of tetrahydrofuran was added dropwise to the reaction solution over 3 hours, and was stirred for 4 hours. The obtained reaction solution was returned to room temperature, white solid was removed by filtration to obtain a filtrate, and the solvent was distilled off from the filtrate under reduced pressure. The obtained crude product was dissolved in toluene and was cleaned with water, and the solvent was distilled off under reduced pressure. As a result, 30.5 g (yield: 71%) of a compound E-1 as a light yellow liquid was obtained.

The synthesized compound E-1 was identified by m/z obtained by ¹H-NMR (device: BRUKER 400) and HPLC-MS.

### Synthesis of Compound E-2

A compound E-2 was synthesized using the same method as that of the synthesis of the compound E-1, except that, during the synthesis of the compound E-1, 1-bromo-2-ethylhexane and FINEOXOCOL 180N were changed to a bromide and an alcohol deriving groups corresponding to R¹ and R² in the chemical formula.

The synthesized compound E-2 was identified using the same method as that of the compound E-1.

### Synthesis of Compound E-3

20.0 g of FINEOXOCOL 180N (branched C₁₈H₃₇OH, manufactured by Nissan Chemical Corporation), 39.4 g of carbon tetrabromide (manufactured by FUJIFILM Wako Pure Chemical Corporation), and 130 g of dichloromethane (manufactured by FUJIFILM Wako Pure Chemical Corporation) were added to a 500 mL three-necked eggplant flask, and the reaction solution was stirred while being cooled in an ice bath. A solution consisting of 39.0 g of triphenylphosphine (manufactured by FUJIFILM Wako Pure Chemical Corporation) and 110 g of dichloromethane was added dropwise to the obtained reaction solution over 10 minutes. Next, the reaction solution was heated to room temperature and stirred for 2 hours. Next, a 4M sodium hydroxide solution was added to this solution, the reaction solution was extracted with dichloromethane, and the solvent was distilled off under reduced pressure. As a result, the product (branched C₁₈H₃₇Br) was obtained as light yellow liquid (yield: 92%).

1.5 g of magnesium (manufactured by FUJIFILM Wako Pure Chemical Corporation) and 100 g of diethyl ether were added to a 300 mL three-necked eggplant flask, and the reaction solution was stirred at room temperature. 18.0 g of the above-described product was added dropwise to the reaction solution to form a Grignard reagent. Next, 4.2 g of dibutyl phosphite was added while maintaining the temperature of the reaction solution at 15° C. or lower, and the reaction solution was heated and was stirred in a reflux state for 5 hours. While cooling the obtained reaction solution in an ice bath, 10% sulfuric acid was added dropwise, the organic layer was cleaned with a 15% sodium carbonate aqueous solution, and the solvent was distilled off under reduced pressure. The obtained crude product was purified by column chromatography, and phosphorous acid including two branched C₁₈H₃₇ groups substituted with two hydroxyl groups, respectively, was obtained as a colorless transparent liquid (yield: 85%).

78 g of hydrogen peroxide water (manufactured by FUJIFILM Wako Pure Chemical Corporation) and 10.0 g of the above-described phosphorous acid were added to a 200 mL three-necked eggplant flask, and the reaction solution was stirred at room temperature. Next, the reaction solution was heated to 65° C. and stirred for 24 hours. After adding 100 g of a saturated sodium thiosulfate aqueous solution, the reaction solution was extracted with toluene, and the solvent was distilled off under reduced pressure. As a result, a compound E-3 was obtained as a colorless transparent liquid (yield: 95%).

The synthesized compound E-3 was identified using the same method as that of the compound E-1.

### [Preparation of Metal Ion-Containing Aqueous Solution W1]

57.2 g of cobalt (II) sulfate heptahydrate (manufactured by FUJIFILM Wako Pure Chemical Corporation) and 57.4 g of nickel (II) sulfate heptahydrate (manufactured by FUJIFILM Wako Pure Chemical Corporation) were added to a 1 L measuring flask, were diluted with ultrapure water, were stirred and dissolved at 40° C., and were cooled to room temperature to prepare a metal ion-containing aqueous solution W1.

### [Preparation of Metal Ion-Containing Aqueous Solution W2]

A metal ion-containing aqueous solution W2 was prepared using the same method as that of the preparation of the metal ion-containing aqueous solution W1, except that 52.7 g of manganese (II) sulfate pentahydrate (manufactured by FUJIFILM Wako Pure Chemical Corporation) was added.

### [Preparation of Metal Ion-Containing Aqueous Solution W3]

A metal ion-containing aqueous solution W3 was prepared using the same method as that of the preparation of the metal ion-containing aqueous solution W1, except that nickel (II) sulfate heptahydrate was not added and the amount of cobalt (II) sulfate heptahydrate used was changed such that the content of Co ions was 36000 ppm.

### [Preparation of Metal Ion-Containing Aqueous Solution W4]

A metal ion-containing aqueous solution W4 was prepared using the same method as that of the preparation of the metal ion-containing aqueous solution W2, except that cobalt (II) sulfate heptahydrate and nickel (II) sulfate heptahydrate were not added, and the amount of manganese (II) sulfate pentahydrate used was changed such that the content of Mn ions was 36000 ppm.

The density (g/cm³) of each of the prepared metal ion-containing aqueous solutions at 25° C. is shown in Table 1-2. The density at 5° C. was within an error range of the density at 25° C.

### <Preparation of Extractant Solution (Oil Phase)>

Each of the synthesized or prepared compounds was added to a 100 mL measuring flask, and was diluted using kerosine (manufactured by FUJIFILM Wako Pure Chemical Corporation) at room temperature. As a result, extractant solutions Y1 to Y8 and Yc1 to Yc3 including the compounds as acidic extractants with contents shown in Table 1-2 were prepared, respectively.

Since kerosine was not used, the extractant solution Y4 was considered as only the compound PC-88A.

The density (g/cm³) of each of the prepared extractant solutions at 25° C. is shown in Table 1-2. The density at 5° C. was within an error range of the density at 25° C.

As an extraction device, the extraction device 1 shown in FIG. 1 was prepared.

Both the inner diameters (equivalent diameters) of the water phase flow pipe 11 and the oil phase flow pipe 12 were 1 mm.

The lengths of the tapered portion 11a and the tapered portion 12a and the inner diameters (equivalent diameters) of the opening end portions thereof were 1 mm and 0.5 mm. Accordingly, the ratio (reduction ratio between the flow diameters) of the inner diameter of the opening end portion of the tapered portion to the inner diameter of each of the flow pipes was 0.5. In addition, each of flow pipes where only the inner diameters (equivalent diameters) of the opening end portions of the tapered portion 11a and the tapered portion 12a were changed to 0.15 mm (the reduction ratio between the flow diameters: 0.15), 0.35 mm (the reduction ratio between the flow diameters: 0.35), 0.55 mm (the reduction ratio between the flow diameters: 0.55), or 0.65 mm (the reduction ratio between the flow diameters: 0.65) was prepared. As the water phase flow pipe 11 and the oil phase flow pipe 12 used in Comparative Example 2, a pipe having the above-described inner diameter up to the combining portion without forming the tapered portion was prepared.

The combining portion 13 was a circular pipe body having the same diameter as the inner diameter of the opening end portions of the tapered portions 11a and 12a, and the length thereof (distance between the water phase flow pipe 11 and the oil phase flow pipe 12) was 2 mm.

The mixing portion 14 includes the front-stage mixing portion 14a and the rear-stage mixing portion 14b consisting of the inverse tapered portion and a pipe portion having a constant inner diameter. A connection aperture (equivalent diameter) of the inverse tapered portion to the combining portion 13 was 0.5 mm, the length of the pipe portion was 100 mm, and the inner diameter (equivalent diameter) of the pipe portion was 1 mm. The length of the rear-stage mixing portion 14b was 100 mm, and the inner diameter (equivalent diameter) of the pipe portion was 1 mm. The total length of the front-stage mixing portion 14a and the rear-stage mixing portion 14b was set by verifying and identifying the time (length) at which the extraction equilibrium was reached for the three-liquid combined solution in advance.

The length of the pH adjusting agent transport pipe 15 was 50 mm, and the inner diameter was 1 mm.

As the separation portion 16, a vial tube having an inner diameter of 36 mm was used.

As an extraction device, the extraction device 2 shown in FIG. 2 was prepared.

In the extraction device 1 including the water phase flow pipe 11 and the oil phase flow pipe 12 where the inner diameters (equivalent diameters) of the opening end portions of the tapered portion 11a and the tapered portion 12a were set to 0.5 mm (reduction ratio between the flow diameters: 0.5), the pH adjusting agent transport pipe 15 was connected to the combining portion 23 (the combining portion 23 was formed) at an angle of the right angle to the water phase flow pipe 11 and the oil phase flow pipe 12 disposed on the same line. As a result, the extraction device 2 was prepared.

### Example 1

<Performing of Extraction Method after One Cycle at 25° C.>

In Example 1, metal ions were extracted under conditions shown in Tables 1-1 to 1-3 using the extraction device 1 including the water phase flow pipe 11 and the oil phase flow pipe 12 having the inner diameters (specifically, 0.5 mm) of the opening end portions of the tapered portion 11a and the tapered portion 12a shown in the column “Water Phase Inner Diameter Ratio” and the column “Oil Phase Inner Diameter Ratio” of Table 1-2.

The metal ion-containing aqueous solution W1 and the extractant solution Y1 started to be fed to the combining portion 13 from the water phase flow pipe 11 and the oil phase flow pipe 12, respectively, at a flow velocity (flow speed) of 6.0 mL/min (inner pressure: 0.06 MPa), the metal ion-containing aqueous solution W1 and the extractant solution Y1 were combined in the combining portion 13, and the combined solution was continuously caused to flow through the mixing portion 14 (step 1). Mixing conditions in the step 1 are shown in the column “Mixing Conditions” of Table 1-2 (the same applies to Examples 2 to 19 and Comparative Examples 1 to 3). After 1 minute or longer was elapsed from the start of the feeding, the pH adjusting agent aqueous solution (4 M sodium hydroxide aqueous solution or 4 M hydrochloric acid) started to be fed from the pH adjusting agent transport pipe 15 to obtain the three-liquid combined solution, and the three-liquid combined solution was additionally caused to flow through the rear-stage mixing portion 14b (step 2). The feeding amount of the pH adjusting agent aqueous solution was adjusted such that the pH of the three-liquid combined solution (water phase) in the rear-stage mixing portion 14b was the value shown in the column “pH during Mixing” of Table 1-2. The flow velocity of the combined solution flowing through the mixing portion 14 was 12.0 mL/min. The mixing temperature in the combining portion 13, the front-stage mixing portion 14a, and the rear-stage mixing portion 14b was 25° C. It was verified that the three-liquid combined solution outflowing from the rear-stage mixing portion 14b already reached the extraction equilibrium by collecting the three-liquid combined solution every 1 minute to the vial tube and verifying that the pH thereof was constant.

This way, the three-liquid combined solution was transported to the vial tube as the separation portion 16 and collected. Next, after leaving the three-liquid combined solution to stand at the same temperature for 30 minutes and verifying that the three-liquid combined solution was separated into two phases of an organic phase (oil phase) and a water phase, the water phase was separated and extracted (step 3) to separate and recover metal ions.

The pH was measured using a pH meter (SK-620 pH II, manufactured by SATOTECH).

Regarding the water phase used in <Performing of Extraction Method after One Cycle at 25° C.> and the water phase after the first extraction separation cycle, each of the contents of dissolved metal ions was determined using an inductively coupled plasma-optical emission spectrometer (ICP-OES) (Optima 7300 D (trade name), manufactured by Perkin Elmer Co., Ltd.). The measured value of the content of the dissolved metal ions in the used water phase is shown in the column “Metal Ion Concentration (ppm) in Water Phase before Extraction” of Table 1-1, and the measured value of the content of the dissolved metal ions in the water phase after one extraction separation cycle is shown in the column “Metal Ion Concentration (ppm) in Water Phase after First Extraction at 25° C.” of Table 1-1.

The metal ions extracted in Example 1 are shown in the column “Kind” of the column “Extracted Metal Ions” of Table 1-2, and the metal ions extracted in the maximum amount are shown in the column “Maximum Extracted Ions” of Table 1-2. The results of the metal ions extracted in <Performing of Extraction Method after 20 Cycles at 25° C.> described below and the metal ions extracted in <Performing of Extraction Method after One Cycle at 5° C.> were the same.

<Performing of Extraction Method after 20 Cycles at 25° C.>

20 extraction separation cycles were continuously performed using the same method as that of <Performing of Extraction Method after One Cycle at 25° C.>, except that the extractant solution Y1 (the used extractant solution Y1) that was phase-separated from the water phase in the separation portion 16 was used as the extractant solution Y1 of the next cycle. That is, the prepared extractant solution Y1 was continuously used in 20 extraction separation cycles. In each of the extraction separation cycles, it was verified that the three-liquid combined solution outflowing from the rear-stage mixing portion 14b already reached the extraction equilibrium.

Each of the oil phases that was phase-separated and recovered in the separation portion 16 was used after stripping the metal ions as follows. That is, 10 mL of purified water was added to 10 mL of the recovered oil phase, 10 M hydrochloric acid was added to adjust the pH of the mixed solution to 1.0, and the reaction solution was stirred at room temperature for 30 minutes and was left to stand at the same temperature for 1 hour. After verifying that the solution was separated into two phases of the organic phase (oil phase) and the water phase, the separated oil phase was extracted. As a result, the oil phase was recovered.

Regarding the water phase obtained by continuously performing 20 extraction separation cycles, the content of dissolved metal ions was determined using the same method as that of <Performing of Extraction Method after One Cycle at 25° C.>. The measured value of the content of the dissolved metal ions in the water phase after 20 extraction separation cycles is shown in the column “Metal Ion Concentration (ppm) in Water Phase after 20th Extraction at 25° C.” of Table 1-1.

<Performing of Extraction Method after One Cycle at 5° C.>

The extraction method after One Cycle was performed at 5° C. using the same method as that of <Performing of Extraction Method after One Cycle at 25° C.>, except that the metal ion-containing aqueous solution W1 and the extractant solution Y1 where the internal temperature was cooled to 5° C. were used (the mixing temperature in the combining portion 13, the front-stage mixing portion 14a, and the rear-stage mixing portion 14b was 5° C.). It was verified that the three-liquid combined solution outflowing from the rear-stage mixing portion 14b already reached the extraction equilibrium.

Regarding the water phase obtained by continuously performing one extraction separation cycle at 5° C., the content of dissolved metal ions was determined using the same method as that of <Performing of Extraction Method after One Cycle at 25° C.>. The measured value of the content of the dissolved metal ions in the water phase after one extraction separation cycles at 5° C. is shown in the column “Metal Ion Concentration (ppm) in Water Phase after First Extraction at 5° C.” of Table 1-1.

### Examples 2 to 18 and Comparative Examples 1 to 3

Regarding each of Examples 2 to 8 and 10 to 17 and Comparative Examples 1 to 3, metal ions were extracted under conditions shown in Tables 1-1 to 1-3 using the extraction device 1 including the water phase flow pipe 11 and the oil phase flow pipe 12 having the inner diameters of the opening end portions of the tapered portion 11a and the tapered portion 12a shown in the column “Water Phase Inner Diameter Ratio” and the column “Oil Phase Inner Diameter Ratio” of Table 1-2. Regarding Example 10, the aqueous solution shown in the column “Water Phase” of Table 1-1 was used as the water phase.

Regarding Examples 9 and 18, metal ions were extracted under conditions shown in Tables 1-1 to 1-3 using the extraction device 1 including the water phase flow pipe 11 and the oil phase flow pipe 12 having the inner diameters of the opening end portions of the tapered portion 11a and the tapered portion 12a shown in the column “Water Phase Inner Diameter Ratio” and the column “Oil Phase Inner Diameter Ratio” of Table 1-2 and including one static mixer having the following characteristics in the rear-stage mixing portion 14b.

### (Characteristics of Static Mixer)

Inner diameter (inner equivalent diameter): 1 mm
Total length: 12 mm
Number of mixing elements: 6
Material: stainless steel
   <Performing of Extraction Method after One Cycle at 25° C.>

<Performing of Extraction Method after One Cycle at 25° C.> of Examples 2 to 18 and Comparative Examples 1 to 3 was performed using the same method as that of <Performing of Extraction Method after One Cycle at 25° C.> of Example 1, except that the metal ion-containing aqueous solution was changed to the metal ion-containing aqueous solution shown in the column “Water Phase” of Table 1-1, the extractant solution was changed to the extractant solution shown in the column “Oil Phase” of Table 1-2, the pH of the three-liquid combined solution (water phase) in the rear-stage mixing portion 14b was set to the value shown in the column “pH during Mixing” of Table 1-2, and the flow velocities of each of Examples 14 to 17 were changed to the flow velocities shown in the column “Water Phase Flow Velocity” and the column “Oil Phase Flow Velocity” in the column “Mixing Conditions” of Table 1-2.

The content of dissolved metal ions in the water phase obtained by performing one extraction separation cycle in each of Examples and Comparative Examples using the same method as that of <Performing of Extraction Method after One Cycle at 25° C.> of Example 1 was determined. The results are shown in the column “Metal Ion Concentration (ppm) in Water Phase after First Extraction at 25° C.” of Table 1-1.

The metal ions extracted in Examples 2 to 18 and Comparative Examples 1 to 3 are shown in the column “Kind” of the column “Extracted Metal Ions” of Table 1-2, and the metal ions extracted in the maximum amount are shown in the column “Maximum Extracted Ions” of Table 1-2. In each of Examples and Comparative Examples, the results of the metal ions extracted in <Performing of Extraction Method after 20 Cycles at 25° C.> and the metal ions extracted in <Performing of Extraction Method after One Cycle at 5° C.> were the same.

<Performing of Extraction Method after 20 Cycles at 25° C.>

<Performing of Extraction Method after 20 Cycles at 25° C.> of Examples 2 to 18 and Comparative Examples 1 to 3 was performed using the same method as that of <Performing of Extraction Method after 20 Cycles at 25° C.> of Example 1, except that the metal ion-containing aqueous solution was changed to the metal ion-containing aqueous solution shown in the column “Water Phase” of Table 1-1, the extractant solution was changed to the extractant solution shown in the column “Oil Phase” of Table 1-2, the pH of the three-liquid combined solution (water phase) in the rear-stage mixing portion 14b was set to the value shown in the column “pH during Mixing” of Table 1-2, and the flow velocities of each of Examples 14 to 17 were changed to the flow velocities shown in the column “Water Phase Flow Velocity” and the column “Oil Phase Flow Velocity” in the column “Mixing Conditions” of Table 1-2.

The content of dissolved metal ions in the water phase obtained by performing 20 extraction separation cycles in each of Examples and Comparative Examples using the same method as that of <Performing of Extraction Method after One Cycle at 25° C.> of Example 1 was determined. The results are shown in the column “Metal Ion Concentration (ppm) in Water Phase after 20th Extraction at 25° C.” of Table 1-1.

<Performing of Extraction Method after One Cycle at 5° C.>

<Performing of Extraction Method after One Cycle at 5° C.> of Examples 2 to 18 and Comparative Examples 1 to 3 was performed using the same method as that of <Performing of Extraction Method after One Cycle at 5° C.> of Example 1, except that the metal ion-containing aqueous solution was changed to the metal ion-containing aqueous solution shown in the column “Water Phase” of Table 1-1, the extractant solution was changed to the extractant solution shown in the column “Oil Phase” of Table 1-2, the pH of the three-liquid combined solution (water phase) in the rear-stage mixing portion 14b was set to the value shown in the column “pH during Mixing” of Table 1-2, and the flow velocities of each of Examples 14 to 17 were changed to the flow velocities shown in the column “Water Phase Flow Velocity” and the column “Oil Phase Flow Velocity” in the column “Mixing Conditions” of Table 1-2.

The content of dissolved metal ions in the water phase obtained by performing one extraction separation cycle at 5° C. in each of Examples and Comparative Examples using the same method as that of <Performing of Extraction Method after One Cycle at 25° C.> of Example 1 was determined. The results are shown in the column “Metal Ion Concentration (ppm) in Water Phase after First Extraction at 5° C.” of Table 1-1.

### Example 19

Regarding Example 19, metal ions were extracted under conditions shown in Tables 1-1 to 1-3 using the above-described extraction device 2. That is, in Example 19, <Performing of Extraction Method after One Cycle at 25° C.>, <Performing of Extraction Method after 20 Cycles at 25° C.>, and <Performing of Extraction Method after One Cycle at 5° C.> were performed using the same method as that of Example 1 under the same mixing conditions, except that the pH during mixing was changed to a value shown in the column “pH during Mixing” of Table 1-2. These results are shown in the column “Metal Ion Concentration (ppm) in Water Phase after First Extraction at 25° C.” the column “Metal Ion Concentration (ppm) in Water Phase after 20th Extraction at 25° C.”, and the column “Metal Ion Concentration (ppm) in Water Phase after First Extraction at 5° C.” of Table 1-1, respectively.

In all of Examples 1 to 19 and Comparative Examples 1 to 3, it was verified that the three-liquid combined solution outflowing from the rear-stage mixing portion 14b already reached the extraction equilibrium.

The metal ions extracted in Examples 1 to 19 and Comparative Examples 1 to 3 are shown in the column “Kind” of the column “Extracted Metal Ions” of Table 1-2, and the metal ions extracted in the maximum amount are shown in the column “Maximum Extracted Ions” of Table 1-2.

### <Evaluation 1: Evaluation of Extraction Rate>

In each of Examples and Comparative Examples, an extraction rate (unit: %) of metal ions extracted in the maximum amount was calculated from the following expression based on a metal ion concentration CI in the prepared water phase (water phase before the first separation extraction cycle) and a metal ion concentration C1 in the water phase obtained in <Performing of Extraction Method after One Cycle at 25° C.> or a metal ion concentration C20 in the water phase after 20 extraction separation cycles in <Performing of Extraction Method after 20 Cycles at 25° C.>. The result is shown in the column “Initial” or the column “20th” of the column “Extraction Rate” of Table 1-2, respectively.

In the present test, as each of the extraction rates increases, the extractability (recovery power) of specific metal ions in each of the extraction separation cycles is higher. In addition, as a difference between the initial extraction rate and the 20th extraction rate (initial extraction rate—20th extraction rate) decreases, even after the acidic extractant (oil phase) is repeatedly used (the extraction separation cycle is repeatedly performed), specific metal ions can be recovered while maintaining high extractability of an unused acidic extractant, the acidic extractant exhibits high durability, and multiple extraction separation cycles can be performed while maintaining an initial high extraction rate (high durability can be realized). In the present test, the durability was evaluated based on the following evaluation standards. The result is shown in the column “Durability” of Table 1-2. In addition, regarding the results of the durability of Comparative Example 1 and Examples 1 to 4, FIG. 4 shows a relationship between the content of the acidic extractant in the oil phase and the extraction rate after 20 extraction separation cycles.

In the present test, for the durability, D or higher is Pass. The initial extraction rate and the 20th extraction rate were evaluated as a reference test, respectively, the initial extraction rate is preferably 95% or more, and the 20th extraction rate is preferably 90% or more.

$$Initial Extraction rate ( \% ) = [ ( CI - C 1 ) / CI ] \times 100$$

$$20 th Extraction Rate ( \% ) = [ ( CI - C 20 ) / CI ] \times 100$$

### -Evaluation Standards-

A: A difference between the initial extraction rate and the 20th extraction rate was 1% or less.
B: A difference between the initial extraction rate and the 20th extraction rate was more than 1% and 4% or less.
C: A difference between the initial extraction rate and the 20th extraction rate was more than 4% and 8% or less.
D: A difference between the initial extraction rate and the 20th extraction rate was more than 8% and 12% or less.
E: A difference between the initial extraction rate and the 20th extraction rate was more than 12% and 16% or less.
F: A difference between the initial extraction rate and the 20th extraction rate was more than 16%.

### <Evaluation 2: Evaluation of Low-Temperature Resolution>

In <Performing of Extraction Method after One Cycle at 5° C.> of each of Examples and Comparative Examples, the amount of metal ions extracted (difference, unit: ppm) was calculated from the metal ion concentration in the water phase before the extraction and the metal ion concentration in the water phase after one extraction separation cycle, and the maximum amount (ppm) of the metal ions extracted was divided by the total amount (ppm) of the other metal ions extracted to calculate low-temperature resolution (selection ratio) as a ratio between the amounts thereof extracted. The result is shown in the column “Low Temperature” of the column “Resolution” of Table 1-2.

In the present test, a higher value of the low-temperature resolution represents that the resolution (selectivity) of the specific metal ions is excellent, and a value of 2.0 or higher is Pass.

The room-temperature resolution in <Performing of Extraction Method after One Cycle at 25° C.> of each of Examples and Comparative Examples was evaluated as a reference test, and was calculated using the same method as that of the low-temperature resolution. The result is shown in the column “Room Temperature” of the column “Resolution” of Table 1-2.

### <Evaluation 3: Evaluation of Amount of Metal Ions Extracted>

In each of Examples and Comparative Examples, metal ions were extracted using the same method as that of <Performing of Extraction Method after One Cycle at 25° C.>, except that the metal ion-containing aqueous solution W3 or W4 shown in Table 1-3 was used instead of the metal ion-containing aqueous solution W1 or W2 shown in Table 1-1, and each of the contents of dissolved metal ions in the used water phase (the metal ion-containing aqueous solution W3 or W4) and the water phase after the extraction was determined. The measured value of the content of the dissolved metal ions in the used water phase is shown in the column “Metal Ion Concentration (ppm) in Water Phase before Extraction” of Table 1-3, and the measured value of the content of the dissolved metal ions in the water phase after one extraction separation cycle is shown in the column “Metal Ion Concentration (ppm) in Water Phase after First Extraction” of Table 1-3.

The amount of metal ions extracted (difference, unit: ppm) was calculated from the metal ion concentration in the water phase before the extraction and the metal ion concentration in the water phase after one extraction separation cycle, and the extraction rate (unit: %) of metal ions extracted in the maximum amount was calculated using the same method as that of <Evaluation 1: Evaluation of Extraction rate>. The result is shown in the column “Amount of Metal Ions Extracted” or the column “Extraction Rate” of Table 1-3.

In the present test, as the amount of metal ions extracted and the extraction rate increase, the amount of metal ions extracted to the oil phase increases, and the mass of metal ions extracted to the oil phase per unit volume increases. In the present test, for the amount of metal ions extracted, 25000 ppm or more is an acceptable level. The extraction rate is a reference test and is preferably 70% or more.

TABLE 1-1

| | | | | | Metal Ion Concentration | | | Metal Ion Concentration | | | Metal Ion Concentration | | |
|---|---|---|---|---|---|---|---|---|---|---|---|---|---|
| | | Metal Ion Concentration | | | (ppm) in Water Phase | | | (ppm) in Water Phase | | | (ppm) in Water Phase | | |
| | | (ppm) in Water Phase | | | after First Extraction | | | after 20th Extraction | | | after First Extraction | | |
| | Water | before Extraction | | | at 25° C. | | | at 25° C. | | | at 5° C. | | |
| No. | Phase | Co | Ni | Mn | Co | Ni | Mn | Co | Ni | Mn | Co | Ni | Mn |
| Example 1 | W1 | 12000 | 12000 | 0 | 0 | 9000 | 0 | 800 | 9200 | 0 | 0 | 8000 | 0 |
| Example 2 | W1 | 12000 | 12000 | 0 | 0 | 9200 | 0 | 300 | 9300 | 0 | 0 | 8100 | 0 |
| Example 3 | W1 | 12000 | 12000 | 0 | 0 | 9500 | 0 | 300 | 9600 | 0 | 0 | 8300 | 0 |
| Example 4 | W1 | 12000 | 12000 | 0 | 0 | 9000 | 0 | 100 | 9100 | 0 | 0 | 8000 | 0 |
| Example 5 | W1 | 12000 | 12000 | 0 | 0 | 9700 | 0 | 400 | 10000 | 0 | 0 | 9000 | 0 |
| Example 6 | W1 | 12000 | 12000 | 0 | 0 | 7200 | 0 | 400 | 7600 | 0 | 0 | 6500 | 0 |
| Example 7 | W1 | 12000 | 12000 | 0 | 0 | 9600 | 0 | 300 | 9700 | 0 | 0 | 9000 | 0 |
| Example 8 | W1 | 12000 | 12000 | 0 | 0 | 10000 | 0 | 300 | 10100 | 0 | 0 | 9200 | 0 |
| Example 9 | W1 | 12000 | 12000 | 0 | 0 | 10900 | 0 | 400 | 11000 | 0 | 0 | 10000 | 0 |
| Example 10 | W2 | 12000 | 12000 | 12000 | 9400 | 12000 | 0 | 9700 | 12000 | 500 | 8500 | 12000 | 0 |
| Comparative | W1 | 12000 | 12000 | 0 | 0 | 9100 | 0 | 1600 | 9500 | 0 | 0 | 8000 | 0 |
| Example 1 | | | | | | | | | | | | | |
| Comparative | W1 | 12000 | 12000 | 0 | 0 | 3500 | 0 | 2800 | 5800 | 0 | 0 | 2000 | 0 |
| Example 2 | | | | | | | | | | | | | |
| Example 11 | W1 | 12000 | 12000 | 0 | 0 | 9400 | 0 | 300 | 9300 | 0 | 0 | 8400 | 0 |
| Example 12 | W1 | 12000 | 12000 | 0 | 0 | 9200 | 0 | 300 | 9300 | 0 | 0 | 8000 | 0 |
| Example 13 | W1 | 12000 | 12000 | 0 | 0 | 9150 | 0 | 300 | 9600 | 0 | 0 | 8000 | 0 |
| Example 14 | W1 | 12000 | 12000 | 0 | 0 | 9350 | 0 | 300 | 9300 | 0 | 0 | 8300 | 0 |
| Example 15 | W1 | 12000 | 12000 | 0 | 0 | 9000 | 0 | 300 | 9300 | 0 | 0 | 8000 | 0 |
| Example 16 | W1 | 12000 | 12000 | 0 | 0 | 9500 | 0 | 300 | 9800 | 0 | 0 | 8300 | 0 |
| Example 17 | W1 | 12000 | 12000 | 0 | 0 | 9500 | 0 | 300 | 9800 | 0 | 0 | 8100 | 0 |
| Example 18 | W1 | 12000 | 12000 | 0 | 0 | 9000 | 0 | 300 | 9300 | 0 | 0 | 8000 | 0 |
| Example 19 | W1 | 12000 | 12000 | 0 | 0 | 9200 | 0 | 700 | 9400 | 0 | 0 | 8100 | 0 |
| Comparative | W1 | 12000 | 12000 | 0 | 0 | 8800 | 0 | 1800 | 9200 | 0 | 0 | 5800 | 0 |
| Example 3 | | | | | | | | | | | | | |

TABLE 1-2

| | | | | | | | Mixing Conditions | | |
|---|---|---|---|---|---|---|---|---|---|
| | Extracted Metal Ions | | | | | | Water | Oil | Water |
| | | Maximum | pH | Oil Phase | | | Phase | Phase | Phase |
| | | Extracted | during | | Acidic | | Flow | Flow | Inner |
| No. | Kind | Ions | Mixing | | Extractant | Content | Velocity | Velocity | Diameter |
| Example 1 | Co, Ni | Co | 5.6 | Y1 | PC-88A | 35 | 6.0 | 6.0 | 1.0 |
| Example 2 | Co, Ni | Co | 5.2 | Y2 | PC-88A | 50 | 6.0 | 6.0 | 1.0 |
| Example 3 | Co, Ni | Co | 4.8 | Y3 | PC-88A | 70 | 6.0 | 6.0 | 1.0 |
| Example 4 | Co, Ni | Co | 4.6 | Y4 | PC-88A | 100 | 6.0 | 6.0 | 1.0 |
| Example 5 | Co, Ni | Co | 5.5 | Y5 | E-1 | 50 | 6.0 | 6.0 | 1.0 |
| Example 6 | Co, Ni | Co | 7.8 | Y6 | VA-10 | 50 | 6.0 | 6.0 | 1.0 |
| Example 7 | Co, Ni | Co | 5.5 | Y7 | E-2 | 50 | 6.0 | 6.0 | 1.0 |
| Example 8 | Co, Ni | Co | 3.7 | Y8 | E-3 | 50 | 6.0 | 6.0 | 1.0 |
| Example 9 | Co, Ni | Co | 3.7 | Y8 | E-1 | 50 | 6.0 | 6.0 | 1.0 |
| Example 10 | Co, Mn | Mn | 3.2 | Y5 | E-1 | 50 | 6.0 | 6.0 | 1.0 |
| Comparative | Co, Ni | Co | 5.7 | Yc1 | PC-88A | 30 | 6.0 | 6.0 | 1.0 |
| Example 1 | | | | | | | | | |
| Comparative | Co, Ni | Co | 5.6 | Yc2 | PC-88A | 35 | 6.0 | 6.0 | 1.0 |
| Example 2 | | | | | | | | | |
| Example 11 | Co, Ni | Co | 5.3 | Y2 | PC-88A | 50 | 6.0 | 6.0 | 1.0 |
| Example 12 | Co, Ni | Co | 5.2 | Y2 | PC-88A | 50 | 6.0 | 6.0 | 1.0 |
| Example 13 | Co, Ni | Co | 5.2 | Y2 | PC-88A | 50 | 6.0 | 6.0 | 1.0 |
| Example 14 | Co, Ni | Co | 5.2 | Y2 | PC-88A | 50 | 18.0 | 18.0 | 1.0 |
| Example 15 | Co, Ni | Co | 5.2 | Y2 | PC-88A | 50 | 2.0 | 2.0 | 1.0 |
| Example 16 | Co, Ni | Co | 5.2 | Y2 | PC-88A | 50 | 12.0 | 12.0 | 1.0 |
| Example 17 | Co, Ni | Co | 5.2 | Y2 | PC-88A | 50 | 12.0 | 12.0 | 1.0 |
| Example 18 | Co, Ni | Co | 7.8 | Y6 | VA-10 | 50 | 6.0 | 6.0 | 1.0 |
| Example 19 | Co, Ni | Co | 5.5 | Y1 | PC-88A | 35 | 6.0 | 6.0 | 1.0 |
| Comparative | Co, Ni | Co | 5.2 | Yc3 | PC-88A | 20 | 6.0 | 6.0 | 1.0 |
| Example 3 | | | | | | | | | |

| | Mixing Conditions | | | | | | | |
|---|---|---|---|---|---|---|---|---|
| | | | Water | Oil | | | Cross | |
| | Oil | Combining | Phase | Phase | | | Sectional | |
| | Phase | Portion | Inner | Inner | Water | Oil | Area of | Water |
| | Inner | Inner | Diameter | Diameter | Phase | Phase | Portion | Phase |
| No. | Diameter | Diameter | Ratio | Ratio | Density | Density | Combining | E_{ST} |
| Example 1 | 1.0 | 0.50 | 0.50 | 0.50 | 1.04 | 0.85 | 0.20 | 69 |
| Example 2 | 1.0 | 0.50 | 0.50 | 0.50 | 1.04 | 0.87 | 0.20 | 69 |
| Example 3 | 1.0 | 0.50 | 0.50 | 0.50 | 1.04 | 0.90 | 0.20 | 69 |
| Example 4 | 1.0 | 0.50 | 0.50 | 0.50 | 1.04 | 0.95 | 0.20 | 69 |
| Example 5 | 1.0 | 0.50 | 0.50 | 0.50 | 1.04 | 0.87 | 0.20 | 69 |
| Example 6 | 1.0 | 0.50 | 0.50 | 0.50 | 1.04 | 0.85 | 0.20 | 69 |
| Example 7 | 1.0 | 0.50 | 0.50 | 0.50 | 1.04 | 0.87 | 0.20 | 69 |
| Example 8 | 1.0 | 0.50 | 0.50 | 0.50 | 1.04 | 0.88 | 0.20 | 69 |
| Example 9 | 1.0 | 0.50 | 0.50 | 0.50 | 1.04 | 0.87 | 0.20 | 69 |
| Example 10 | 1.0 | 0.50 | 0.50 | 0.50 | 1.06 | 0.87 | 0.20 | 70 |
| Comparative | 1.0 | 0.50 | 0.50 | 0.50 | 1.04 | 0.83 | 0.20 | 69 |
| Example 1 | | | | | | | | |
| Comparative | 1.0 | 1.00 | 1.00 | 1.00 | 1.04 | 0.85 | 0.79 | 1 |
| Example 2 | | | | | | | | |
| Example 11 | 1.0 | 0.35 | 0.35 | 0.35 | 1.04 | 0.87 | 0.10 | 584 |
| Example 12 | 1.0 | 0.15 | 0.15 | 0.15 | 1.04 | 0.87 | 0.02 | 94229 |
| Example 13 | 1.0 | 0.65 | 0.65 | 0.65 | 1.04 | 0.87 | 0.33 | 14 |
| Example 14 | 1.0 | 0.35 | 0.35 | 0.35 | 1.04 | 0.87 | 0.10 | 15765 |
| Example 15 | 1.0 | 0.35 | 0.35 | 0.35 | 1.04 | 0.87 | 0.10 | 22 |
| Example 16 | 1.0 | 0.35 | 0.35 | 0.35 | 1.04 | 0.87 | 0.10 | 4671 |
| Example 17 | 1.0 | 0.55 | 0.55 | 0.55 | 1.04 | 0.87 | 0.24 | 310 |
| Example 18 | 1.0 | 0.50 | 0.50 | 0.50 | 1.04 | 0.85 | 0.20 | 69 |
| Example 19 | 1.0 | 0.50 | 0.50 | 0.50 | 1.04 | 0.85 | 0.20 | 69 |
| Comparative | 1.0 | 0.50 | 0.50 | 0.50 | 1.04 | 0.87 | 0.20 | 69 |
| Example 3 | | | | | | | | |

| | Mixing Conditions | | | | | | | |
|---|---|---|---|---|---|---|---|---|
| | Oil | | | Extraction | | | Resolution | |
| | Phase | Extraction | | Rate (%) | | | Room | Temperature |
| No. | E_{ST} | Device | Mixer | Initial | 20th | Durability | Temperature | Low |
| Example 1 | 56 | 1 | Not Provided | 100 | 93 | C | 4.0 | 3.0 |
| Example 2 | 57 | 1 | Not Provided | 100 | 98 | B | 4.3 | 3.1 |
| Example 3 | 60 | 1 | Not Provided | 100 | 98 | B | 4.8 | 3.2 |
| Example 4 | 63 | 1 | Not Provided | 100 | 99 | A | 4.0 | 3.0 |
| Example 5 | 58 | 1 | Provided | 100 | 97 | B | 5.2 | 4.0 |
| Example 6 | 56 | 1 | Not Provided | 100 | 97 | B | 2.5 | 2.2 |
| Example 7 | 58 | 1 | Not Provided | 100 | 98 | B | 5.0 | 4.0 |
| Example 8 | 58 | 1 | Not Provided | 100 | 98 | B | 6.0 | 4.3 |
| Example 9 | 58 | 1 | Provided | 100 | 97 | B | 10.9 | 6.0 |
| Example 10 | 58 | 1 | Not Provided | 100 | 96 | B | 4.6 | 3.4 |
| Comparative | 55 | 1 | Not Provided | 100 | 87 | E | 4.1 | 3.0 |
| Example 1 | | | | | | | | |
| Comparative | 1 | 1 | Not Provided | 100 | 77 | F | 1.4 | 1.2 |
| Example 2 | | | | | | | | |
| Example 11 | 488 | 1 | Not Provided | 100 | 98 | B | 4.6 | 3.3 |
| Example 12 | 78826 | 1 | Not Provided | 100 | 98 | B | 4.3 | 3.0 |
| Example 13 | 12 | 1 | Not Provided | 100 | 98 | B | 4.2 | 3.0 |
| Example 14 | 13188 | 1 | Not Provided | 100 | 98 | B | 4.5 | 3.2 |
| Example 15 | 18 | 1 | Not Provided | 100 | 98 | B | 4.0 | 3.0 |
| Example 16 | 3908 | 1 | Not Provided | 100 | 98 | B | 4.8 | 3.2 |
| Example 17 | 259 | 1 | Not Provided | 100 | 98 | B | 4.8 | 3.1 |
| Example 18 | 56 | 1 | Provided | 100 | 97 | B | 4.0 | 3.0 |
| Example 19 | 56 | 2 | Not Provided | 100 | 93 | C | 4.3 | 3.1 |
| Comparative | 57 | 1 | Not Provided | 100 | 85 | E | 3.8 | 1.9 |
| Example 3 | | | | | | | | |

TABLE 1-3

| | | | | | | | Mixing |
|---|---|---|---|---|---|---|---|
| | | | | Oil Phase | | | Conditions |
| | | | pH | | | Content | Inner |
| | Water | Extracted | during | | Metal | (% by | diameter |
| No. | Phase | Ion | Mixing | | Extractant | Volume) | Ratio |
| Example 1 | W3 | Co | 5.6 | Y1 | PC-88A | 35 | 0.50 |
| Example 2 | W3 | Co | 5.2 | Y2 | PC-88A | 50 | 0.50 |
| Example 3 | W3 | Co | 4.8 | Y3 | PC-88A | 70 | 0.50 |
| Example 4 | W3 | Co | 4.6 | Y4 | PC-88A | 100 | 0.50 |
| Example 5 | W3 | Co | 5.5 | Y5 | E-1 | 50 | 0.50 |
| Example 6 | W3 | Co | 7.8 | Y6 | VA-10 | 50 | 0.50 |
| Example 7 | W3 | Co | 5.5 | Y7 | E-2 | 50 | 0.50 |
| Example 8 | W3 | Co | 3.7 | Y8 | E-3 | 50 | 0.50 |
| Example 9 | W3 | Co | 3.7 | Y8 | E-1 | 50 | 0.50 |
| Example 10 | W4 | Mn | 3.2 | Y5 | E-1 | 50 | 0.50 |
| Comparative | W3 | Co | 5.7 | Yc1 | PC-88A | 30 | 0.50 |
| Example 1 | | | | | | | |
| Comparative | W3 | Co | 5.6 | Yc2 | PC-88A | 35 | 1.00 |
| Example 2 | | | | | | | |
| Example 11 | W3 | Co | 5.3 | Y2 | PC-88A | 50 | 0.35 |
| Example 12 | W3 | Co | 5.2 | Y2 | PC-88A | 50 | 0.15 |
| Example 13 | W3 | Co | 5.2 | Y2 | PC-88A | 50 | 0.65 |
| Example 14 | W3 | Co | 5.2 | Y2 | PC-88A | 50 | 0.35 |
| Example 15 | W3 | Co | 5.2 | Y2 | PC-88A | 50 | 0.35 |
| Example 16 | W3 | Co | 5.2 | Y2 | PC-88A | 50 | 0.35 |
| Example 17 | W3 | Co | 5.2 | Y2 | PC-88A | 50 | 0.55 |
| Example 18 | W3 | Co | 7.8 | Y6 | VA-10 | 50 | 0.50 |
| Example 19 | W3 | Co | 5.5 | Y1 | PC-88A | 35 | 0.50 |
| Comparative | W3 | Co | 5.2 | Yc3 | PC-88A | 20 | 0.50 |
| Example 3 | | | | | | | |

| | | | Metal Ion | | |
|---|---|---|---|---|---|
| | | Metal Ion | Concentration | | Amount |
| | Mixing | Concentration | (ppm) in | | of Metal |
| | Conditions | (ppm) in Water | Water Phase | | Ions |
| | Static | Phase before | after First | Extraction | Extracted |
| No. | Mixer | Extraction | Extraction | Rate (%) | (ppm) |
| Example 1 | Not Provided | 36000 | 7500 | 79 | 28500 |
| Example 2 | Not Provided | 36000 | 5000 | 86 | 31000 |
| Example 3 | Not Provided | 36000 | 0 | 100 | 36000 |
| Example 4 | Not Provided | 36000 | 1500 | 96 | 34500 |
| Example 5 | Not Provided | 36000 | 4900 | 86 | 31100 |
| Example 6 | Not Provided | 36000 | 4500 | 88 | 31500 |
| Example 7 | Not Provided | 36000 | 5100 | 86 | 30900 |
| Example 8 | Not Provided | 36000 | 3800 | 89 | 32200 |
| Example 9 | Provided | 36000 | 0 | 100 | 36000 |
| Example 10 | Not Provided | 36000 | 6200 | 83 | 29800 |
| Comparative | Not Provided | 36000 | 23000 | 36 | 13000 |
| Example 1 | | | | | |
| Comparative | Not Provided | 36000 | 7900 | 78 | 28100 |
| Example 2 | | | | | |
| Example 11 | Not Provided | 36000 | 4000 | 89 | 32000 |
| Example 12 | Not Provided | 36000 | 5000 | 86 | 31000 |
| Example 13 | Not Provided | 36000 | 5300 | 85 | 30700 |
| Example 14 | Not Provided | 36000 | 4200 | 88 | 31800 |
| Example 15 | Not Provided | 36000 | 6000 | 83 | 30000 |
| Example 16 | Not Provided | 36000 | 4300 | 88 | 31700 |
| Example 17 | Not Provided | 36000 | 4600 | 87 | 31400 |
| Example 18 | Provided | 36000 | 2000 | 94 | 34000 |
| Example 19 | Not Provided | 36000 | 6500 | 82 | 29500 |
| Comparative | Not Provided | 36000 | 25000 | 31 | 11000 |
| Example 3 | | | | | |

In Table 1-2, “Water Phase Flow Velocity” and “Oil Phase Flow Velocity” represent “the flow velocities” of the water phase and the oil phase, and “Water Phase Inner Diameter”, “Oil Phase Inner Diameter”, and “Combining Portion Inner Diameter” represent the inner diameters (equivalent diameters) of the water phase flow pipe 11, the oil phase flow pipe 12, and the combining portion. In addition, “Water Phase Inner Diameter Ratio” or “Oil Phase Inner Diameter Ratio” represent the ratio (reduction ratio between the flow diameters) of the inner diameter of the opening end portion of the tapered portion to the inner diameter of the flow pipe 11 or 12. “Water Phase Est” or “Oil Phase Est” represents the kinetic energy EsT of the water phase or the oil phase. In Table 1-2, the unit of “Content” of the acidic extractant is “% by volume”, the unit of “Flow Velocity” is “mL/min”, the unit of “Inner Diameter” is “mm”, the unit of “Density” is “g/cm³”, the unit of “Cross Sectional Area” is “mm²”, and the unit of “EST” is “J/sec/cm²”, which are omitted.

The following can be seen from the results and the like shown in Tables 1-1 to 1-3 and FIG. 4.

In Comparative Examples 1 and 3 where the content of the acidic extractant in the oil phase was excessively small although the flow type mixing method was adopted, the amount of metal ions extracted and the durability were poor. The reason why the durability was poor is presumed to be that the acidic extractant deteriorated and was decomposed by the pH adjusting agent or the like. In addition, in Comparative Example 2 where the flow diameters were not reduced before combining the water phase and the oil phase although the flow type mixing method was adopted, the durability and the resolution were poor. One of the reasons for this is presumed to be that both the phases were not able to be sufficiently mixed in the combining portion.

On the other hand, in all of Examples 1 to 19 where the flow type mixing method was adopted, the oil phase including 35% to 100% by volume of the acidic extractant was used, and the flow diameters were reduced before combining the water phase and the oil phase, the maximum amount of metal ions (in Examples 1 to 9 and 11 to 19: Co ions, Example 10: Mn ions) among two kinds of metal ions present in the water phase were able to be extracted to the oil phase in a large amount with high durability and high resolution. In addition, in Examples 9 and 18 where the static mixer was used, the resolution, the extraction rate, and the amount of metal ions extracted were significantly improved, and even in a case where the extractant VA-10 in the related art having poor extractability was used (Example 18), the resolution, the extraction rate, and the amount of metal ions extracted were able to be simultaneously realized at a higher level.

This way, it can be seen that, with the extraction method according to the embodiment of the present invention, specific metal ions among two or more kinds of metal ions belonging to different groups having similar physical behaviors and similar chemical behaviors, in particular, one kind of metal ions among metal ions belonging to Groups 7, 9 and 10 that can be recovered from waste LiB can be separated and recovered in a large amount with high durability and high resolution (high selectivity).

From the above results, it can be seen that, by stripping the oil phase obtained in each of Examples using a typical method and conditions, the metal ions can be extracted to the oil phase in a large amount with high resolution and can be separated and recovered in a large amount simply and with high productivity without deterioration in high selectivity.

Incidentally, in the technique of recovering specific metal ions from the water phase including a plurality of metal ions, it is generally difficult to recover the specific metal ions in a large amount with high resolution, and in a case where high resolution is maintained, the amount of metal ions extracted decreases. Therefore, in order to achieve a predetermined amount of metal ions extracted, currently, it is required to perform multiple extraction separation cycles. On the other hand, in the present invention, with the simple flow type mixing method having high workability, one kind of metal ions among two kinds of different-group metal ions can be extracted from the water phase to the oil phase in a large amount with high durability and high resolution. Therefore, in consideration of the current conditions, the technical significance of the present invention is high from the viewpoint that, through the stripping step or the like from the obtained oil phase, one kind of metal ions can be simply recovered in a large amount with high productivity while further improving high resolution (high selectivity).

The present invention has been described with the embodiments thereof, any details of the description of the present invention are not limited unless described otherwise, and it is obvious that the present invention is widely construed without departing from the gist and scope of the present invention described in the accompanying claims.

The present application claims priority based on JP2023-165476 filed on Sep. 27, 2023 and JP2024-055406 filed on Mar. 29, 2024, the entire contents of which are incorporated herein by reference.

### EXPLANATION OF REFERENCES

1,2: extraction device
11: water phase flow pipe
11a: tapered portion
11b: large-diameter portion
11c: small diameter portion
12: oil phase flow pipe
12a: tapered portion
13, 23: combining portion
14, 24: mixing portion
14a: front-stage mixing portion
14b: rear-stage mixing portion
15: pH adjusting agent transport pipe
16: separation portion
16a: oil phase discharge pipe
16b: water phase discharge pipe

What is claimed is:

1. A method of extracting metal ions in which a water phase including metal ions and an oil phase including an acidic extractant are combined to be mixed while flowing, subsequently the mixture is phase-separated into a water phase and an oil phase to extract the metal ions to the oil phase, and
a content of the acidic extractant in the oil phase that is caused to flow is 35% to 100% by volume, the method comprising:
a step of reducing a flow diameter of each of the water phase and the oil phase that are flowing, combining the water phase and the oil phase, and continuously causing a two-liquid combined solution to flow; a step of combining the water phase, the oil phase, and a pH adjusting agent aqueous solution and additionally causing a three-liquid combined solution to flow; and
a step of phase-separating the three-liquid combined solution after extraction of metal ions to be extracted reaches an extraction equilibrium.

2. The method of extracting metal ions according to claim 1,
wherein in the additional flow step, the two-liquid combined solution of the water phase and the oil phase that are combined in the continuous flow step is combined with the pH adjusting agent aqueous solution, and the three-liquid combined solution is additionally caused to flow.

3. The method of extracting metal ions according to claim 1,
wherein in the continuous flow step, the additional flow step is performed to combine the water phase, the oil phase, and the pH adjusting agent aqueous solution at a stroke, and a three-liquid combined solution is additionally caused to flow.

4. The method of extracting metal ions according to claim 1,
wherein in at least one of the continuous flow step or the additional flow step, the combined solution is caused to flow in a flow path where a static mixer is provided.

5. The method of extracting metal ions according to claim 1,
wherein the water phase and the oil phase are combined using collision of the respective phases that are flowing.

6. The method of extracting metal ions according to claim 1,
wherein in a case where the water phase and the oil phase are combined, a reduction ratio between the flow diameters is 0.1 to 0.8.

7. The method of extracting metal ions according to claim 1,
wherein in a case where the water phase and the oil phase are combined using collision of the respective phases that are flowing, kinetic energy of the water phase and the oil phase per unit area and per unit time is 50 to 100000 J/sec/m².

8. The method of extracting metal ions according to claim 1,
wherein the three-liquid combined solution is left to stand to be phase-separated into the water phase and the oil phase.

9. The method of extracting metal ions according to claim 1,
wherein the metal ions include plural kinds of metal ions, and at least one kind of metal ions among the plural kinds of metal ions is separated and extracted from other kinds of metal ions.

10. The method of extracting metal ions according to claim 1,
wherein multiple extraction separation cycles consisting of the continuous flow step, the additional flow step, and the phase separation step are performed, and
the oil phase that is phase-separated in the phase separation step is reused as an oil phase of a next extraction separation cycle.

11. The method of extracting metal ions according to claim 1,
wherein the acidic extractant includes a phosphoric acid-based compound.

12. The method of extracting metal ions according to claim 11,
wherein the acidic extractant is represented by Formula (I), 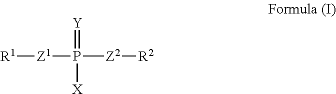
in Formula (I), R¹ and R² represent a substituent, in which at least one of R¹ or R² represents a hydrocarbon group having 9 or more carbon atoms, X represents —OH or —SH,
Y represents an oxygen atom or a sulfur atom, and Z¹ and Z² represent a single bond, —O—, —NH—, or —S—.
